(19) United States
(12) Patent Application Publication
(10) Pub. No.: US 2010/0135255 A1
(43) Pub. Date: Jun. 3, 2010

(54) METHOD FOR DETACHING USER EQUIPMENT

(75) Inventors: Wanqiang Zhang, Shenzhen (CN); Xiaolong Guo, Shenzhen (CN); Lan Liu, Shenzhen (CN)

Correspondence Address: Huawei Technologies Co., Ltd.;c/o Darby & Darby P.C., P.O. Box 770, Church Street Station, New York, NY, 10008-0770, US

(73) Assignee: HUAWEI TECHNOLOGIES CO., LTD., Shenzhen (CN)

(21) Appl. No.: 12/700,476

(22) Filed: Feb. 4, 2010

Related U.S. Application Data
(63) Continuation of application No. PCT/CN2008/072024, filed on Aug. 18, 2008.

(30) Foreign Application Priority Data
Aug. 20, 2007 (CN) 200710142033.X
Oct. 24, 2007 (CN) 200710182045.5

(51) Int. Cl. H04W 36/00

(52) U.S. Cl. 370/331

(57) ABSTRACT

A method for detaching User Equipment (UE) is disclosed to detach the UE in case of signaling reduction. The method includes the following steps: a UE detachment operation of a first network access control entity is triggered, where the detachment operation is a complete detachment operation; the first network access control entity detaches the UE according to the detachment operation type, and triggers the complete detachment of a second network access control entity; and the second network access control entity performs the detachment operation according to the trigger operation of the first network access control entity. Thus, after the UE is detached from a network access control entity, the network access control entity may notify another network access control entity by various means, so that another network access entity implements subsequent processes.

### CROSS-REFERENCE TO RELATED APPLICATIONS

This application is a continuation of International Application No. PCT/CN2008/072024, filed on Aug. 18, 2008, which claims priority to Chinese Patent Application No. 200710142033.X, filed on Aug. 20, 2007 and Chinese Patent Application No. 200710182045.5, filed on Oct. 24, 2007, all of which are hereby incorporated by reference in their entireties.

### FIELD OF THE INVENTION

The present invention relates to the filed of radio communication technologies, and in particular, to a method for detaching a user equipment.

### BACKGROUND OF THE INVENTION

A universal mobile telecommunication system (UMTS) is a third-generation radio communication network standard defined by the Third Generation Partnership Project (3GPP) organization. The UMTS includes a core network and an access network. The core network includes a circuit switched (CS) domain and a packet switched (PS) domain. The CS domain provides CS-based services, and the PS domain provides PS-based services. A terminal used by a mobile user is a user equipment (UE).

The PS domain of the core network includes a Serving GPRS Support Node (SGSN), a Gateway GPRS Support Node (GGSN) and a Home Location Register (HLR). The access network includes a Radio Network Controller (RNC) and a NodeB. Each RNC may be connected to multiple NodeBs, and each SGSN may be connected to multiple RNCs. The SGSNs are connected via the Iu interface. The SGSN and the GGSN each is connected to the HLR.

In the 3GPP, manufacturers are studying on long term evolved (LTE)/system architecture evolved (SAE) networks. The purpose of the LTE is to provide a cost-effective network, which has the features of low delay, increased user data rate, improved system capacity and coverage. The LTE network uses PS-based services, but the bearer network of the LTE network is an IP network.

The following describes the architecture and functions of an SAE network. In an evolved packet core network:

A Mobility Management Entity (MME) is adapted to store mobility management contexts of a UE, for example, user ID, mobility management state, and location information.

An SAE gateway includes a Serving Gateway (S-GW) and a Packet Data Network (PDN) Gateway (P-GW). The S-GW and the P-GW are two logical entities and may be configured in a same physical entity or different physical entities.

The S-GW stores user plane contexts of the UE, for example, IP address and routing information about the UE, and is responsible for lawful interception and packet data routing. The S-GW exchanges mobility management information and session control information about the UE with the MME via an S11 interface.

The MME is responsible for establishing a control plane connection with the access network in the evolved network through the S1-MME; the S-GW is responsible for establishing a user plane connection with the access network in the evolved network through the S1-U. In addition, the MME is connected to the 2G/3G SGSN via an S3 interface, and is responsible for anchor point functions of the mobility control plane between the 2G/3G network and the SAE network; the S-GW is connected to the 2G/3G SGSN via an S4 interface, and is responsible for anchor point functions of the user plane between the 2G/3G network and the SAE network.

The P-GW is responsible for anchor point functions of the user plane of the UE accessing a PDN, and communicates with an external PDN via an SGi reference point. The P-GW has packet routing and forwarding functions, and is also responsible for enhanced policy charging functions and packet filtering functions based on a user. The P-GW is connected to the S-GW via an S5 interface, transferring control information such as bearer establishment, modification or deletion, and routing packet data.

A policy and charging rules function (PCRF) transfers quality of service (QoS) information and charging policy control information via an S7 interface.

The UE moves between the SAE network and the 2G/3G network with different radio access technologies (RATs), which may cause frequent network registration processes and thus wastes a lot of air interface resources. As shown in FIG. 1, RA1 and RA2 are routing areas (RAs) in the current 2G/3G network. The UE in the current 2G/3G network always initiates a routing area update (RAU) process when changing an RA. TA1, TA2, TA3 and TA4 are tracking areas (TAs) in the evolved network, which are similar to the RA in the 2G/3G network. When a multi-mode UE moves in these areas, frequent network registration processes may occur if there is lack of a mechanism. For example, the UE registers with the 2G/3G SGSN when entering the RA1; the UE registers with the MME in the evolved network when entering the TA1; the UE registers with the 2G/3G SGSN when moving out of the TA1 and entering the RA1 again. The purpose of registration is to enable the network to page the UE in an RAT. But, frequent registrations cause huge registration signaling overheads.

Signaling reduction aims to avoid huge registration signaling overheads caused by frequent registrations. After the UE registers in an access network after being attached to the access network such as a 2G/3G network or an evolved network; the UE registers in another access network after moving to another access network; the UE registers in two access systems at the same time. Then, the UE moves in a registration area in these two access networks, that is, the RA or the TA, without initiating any registration processes. The UE needs to initiate only an ordinary RAU process when changing the RA or the TA.

In a signaling reduction technology in the prior art, the UE registers in two systems at the same time. The two systems may register with a home subscriber server (HSS), which is called double registration, that is, the SGSN and the MME register with the HSS; or one of them registers with the HSS, which is called single registration, that is, only the SGSN or the MME registers with the HSS. In case of single registration or double registration, the SGSN or MME that generates a signaling reduction association may always record the information about the associated MME or SGSN.

### SUMMARY OF THE INVENTION

Embodiments of the present invention provide a method for detaching a UE. In the method, after a system detaches a UE, the system notifies another system that the UE is detached or triggers a UE detachment operation of another system.

A method for detaching a UE in an embodiment of the present invention includes:

triggering a UE detachment operation of a first network access control entity, wherein the type of the detachment operation is a complete detachment operation;

performing, by the first network access control entity, the detachment operation according to the type of detachment operation;

triggering, by the first network access control entity, the complete detachment operation of a second network access control entity; and

performing, by the second network access control entity, the detachment operation according to the trigger operation of the first network access control entity.

Another method for detaching a UE in an embodiment of the present invention includes:

triggering a UE detachment operation of a first network access control entity, where the type of the detachment operation is a single detachment operation;

performing, by the first network access control entity, the detachment operation according to the type of detachment operation; and

notifying a second network access control entity that the first network access control entity has detached the UE.

Another method for detaching a UE in an embodiment of the present invention includes:

triggering, by a first network access control entity, a UE detachment operation of a second network access control entity, where the type of the detachment operation is a single detachment operation; and

performing, by the second network access control entity, the detachment operation according to the type of the detachment operation.

A system for detaching a UE in an embodiment of the present invention includes:

a first network access control entity for determining to trigger complete detachment operation according to a preset condition, performing the detachment operation; and triggering the complete detachment operation of a second network access control entity;

the second network access control entity for performing the complete detachment operation of a second network access control entity.

### BRIEF DESCRIPTION OF THE DRAWINGS

FIG. 1 shows a structure diagram of a network with different RATs in the prior art;

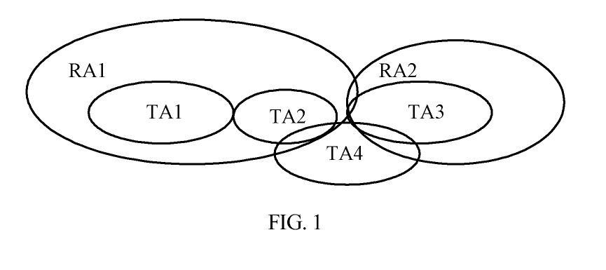

FIG. 2 is a flowchart of a method for detaching a UE according to a first embodiment of the present invention;

FIG. 3 is a flowchart of a method for detaching a UE according to a second embodiment of the present invention;

FIG. 4 is a flowchart of a method for detaching a UE according to a third embodiment of the present invention;

FIG. 5 is a flowchart of a method for detaching a UE according to a fourth embodiment of the present invention;

FIG. 6 is a flowchart of a method for detaching a UE according to the present invention;

FIG. 7 is a flowchart of a sixth embodiment of a method for detaching a UE according to a fifth embodiment of the present invention;

FIG. 8 is a flowchart of a method for detaching a UE according to a seventh embodiment of the present invention;

FIG. 9 is a flowchart of a method for detaching a UE according to an eighth embodiment of the present invention;

FIG. 10 is a flowchart of a method for detaching a UE according to a ninth embodiment of the present invention;

FIG. 11 is a flowchart of a method for detaching a UE according to a tenth embodiment of the present invention;

FIG. 12 is a flowchart of a method for detaching a UE according to an eleventh embodiment of the present invention;

FIG. 13 is a flowchart of a method for detaching a UE according to a twelfth embodiment of the present invention;

FIG. 14 is a flowchart of a method for detaching a UE according to a thirteenth embodiment of the present invention;

FIG. 15 is a flowchart of a method for detaching a UE according to a fourteenth embodiment of the present invention;

FIG. 16 is a flowchart of a method for detaching a UE according to a fifteenth embodiment of the present invention;

FIG. 17 is a flowchart of a method for detaching a UE according to a sixteenth embodiment of the present invention;

FIG. 18 is a flowchart of a method for detaching a UE according to a seventeenth embodiment of the present invention;

FIG. 19 is a flowchart of a method for detaching a UE according to an eighteenth embodiment of the present invention;

FIG. 20 is a flowchart of a method for detaching a UE according to a nineteenth embodiment of the present invention;

FIG. 21 is a flowchart of a method for detaching a UE according to a twentieth embodiment of the present invention;

FIG. 22 is a flowchart of a method for detaching a UE according to a twenty-first embodiment of the present invention; and

FIG. 23 is a flowchart of a method for detaching a UE according to a twenty-second embodiment of the present invention.

### DETAILED DESCRIPTION OF THE INVENTION

In the prior art, a UE, an SGSN/MME, or an HSS may initiate a detachment operation of the UE. But, in the prior art, the process of detaching a UE in case of signaling reduction is not provided. In addition, when a system detaches a UE, the system does not trigger a UE detachment operation of another system or not notify another system that the UE is already detached from the system. For example, after the UE is detached from the SGSN, the SGSN does not notify the MME that the UE is already detached from the SGSN. In subsequent processes, the MME is still associated with the SGSN where the UE is detached because the MME does not know that the UE is detached from the SGSN. This causes unnecessary operation process errors.

An embodiment of the present invention provides a method for detaching a UE in case of signaling reduction.

In the embodiment of the present invention, it is assumed that the MME acts as a first network control entity and that the SGSN acts as a second network control entity. In practice, the MME may also act as the second network control entity, and the SGSN may also act as the first network control entity. It should be noted that the information about two systems may be registered in the HSS after signaling reduction is activated. That is, the HSS may record the information about the SGSN and the MME where the UE registers, which is called double registration. Single registration means that the information about only one system is registered in the HSS after signaling reduction is activated and the information about other systems where the UE registers is stored in another system, for example, the HSS records only the information about a system where the UE initiates the last update. For example, if the UE registers in a 2G/3G network, the HSS records the information about the SGSN where the UE registers by sending a location update message to the HSS via the SGSN; when the UE moves to another RAT SAE system, the UE initiates the location update, and registers with the MME in the SAE system. After signaling reduction is activated, the MME sends a location update message to the HSS; the HSS records the information about the MME and deletes the information about the SGSN, but the information about the SGSN is stored in the MME. That is, the SGSN and the MME record the information about the UE, but the HSS reserves the information about only one system.

The following describes a process of detaching a UE in various networks in case of signaling reduction with reference to the accompanying drawings.

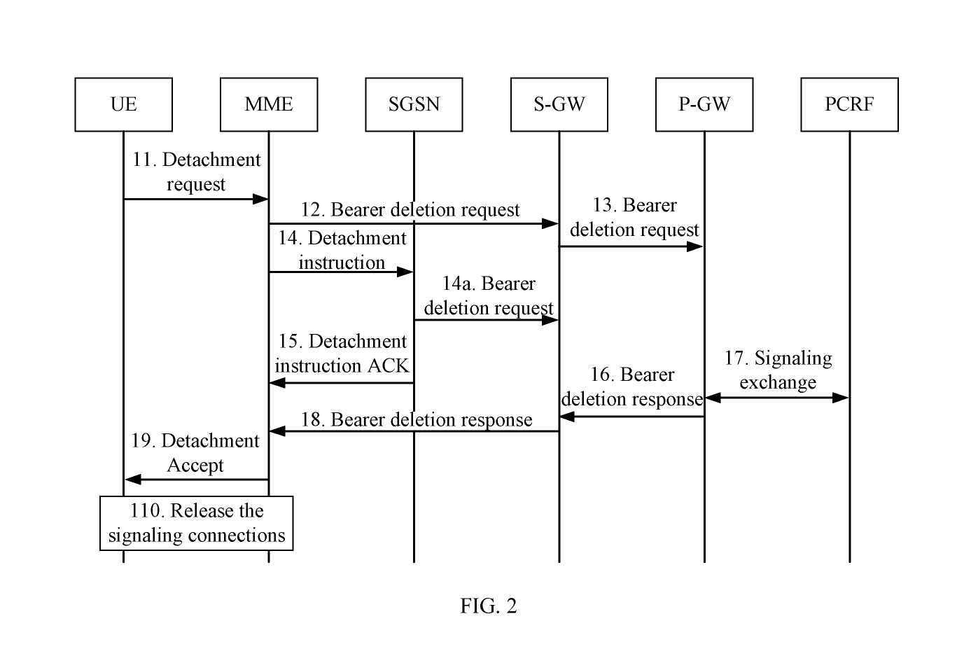

FIG. 2 is a flowchart of a method for detaching a UE according to the first embodiment of the present invention.

In the first embodiment, a UE initiates complete detachment in an LTE network in case of double registration.

Step 11: The UE sends a detachment request that carries a complete detachment indication to an MME.

Step 12: After receiving the complete detachment request, the MME sends a bearer deletion request to an S-GW, and instructs the S-GW to delete all session management (SM) contexts.

After the S-GW deletes all the SM contexts, the process goes to step 13. In step 12, if the bearer deletion request that the MME sends to the S-GW does not carry the indication, the S-GW deletes SAE-related SM contexts only.

Step 13: The S-GW sends a bearer deletion request to a P-GW.

The P-GW deletes all the bearer information about the UE.

Step 14: The MME sends a detachment indication that indicates complete detachment to an SGSN.

The detachment indication may include a cause value indicating that the SGSN does not need to initiate bearer deletion to the S-GW. If the bearer deletion request that the MME sends to the S-GW does not carry the indication in step 12, the detachment indication may not include the cause value indicating that the SGSN does not need to initiate bearer deletion to the S-GW. Then, the process goes to step 14a. If an lu connection exists between the SGSN and the UE, the SGSN releases the lu connection.

Step 14a: The SGSN sends a bearer deletion request to the S-GW, where the bearer deletion request may include a cause value indicating that the S-GW does not need to initiate bearer deletion to the P-GW or not include the cause value. The S-GW returns a bearer deletion response to the SGSN.

Step 15: The SGSN returns a detachment indication Acknowledgement (ACK) to the MME.

Step 16: The P-GW returns a bearer deletion response to the S-GW.

Step 17: The P-GW exchanges signaling messages with a PCRF.

Step 17 may be executed in certain conditions. The P-GW may notify the PCRF that all bearers to be deleted are already deleted.

Step 18: The S-GW returns a bearer deletion response to the MME.

Step 19: The MME returns a detachment Accept message to the UE.

This step is executed only when the UE is not powered off.

Step 110: The signaling connections are released.

The signaling connections between the UE and the NodeB, and between the NodeB and the MME are released.

The process of initiating complete detachment by the UE in a 2G/3G network is the same as the above process, and is not further described.

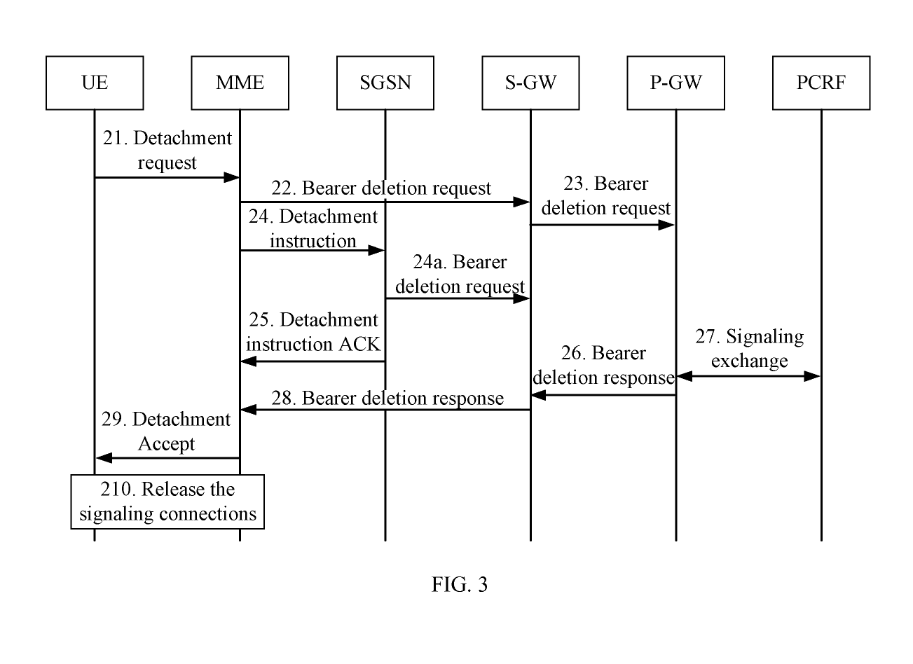

FIG. 3 is a flowchart of a method for detaching a UE according to the second embodiment of the present invention.

In the second embodiment, the MME initiates a complete detachment request in case of double registration.

Step 21: The MME sends a detachment request that carries a complete detachment indication to the UE.

Step 22: The MME sends a bearer deletion request to the S-GW, and instructs the S-GW to delete all the SM contexts.

In this step, if the bearer deletion request that the MME sends to the S-GW does not carry the indication, the S-GW deletes SAE-related SM contexts only.

Step 23: The S-GW initiates bearer deletion to the P-GW.

Step 24: The MME sends a detachment indication that indicates complete detachment to the SGSN.

The detachment indication may include a cause value indicating that the SGSN does not need to initiate bearer deletion to the S-GW. If the bearer deletion request that the MME sends to the S-GW does not carry the indication in step 22, the detachment indication may not include the cause value indicating that the SGSN does not need to initiate bearer deletion to the S-GW. In this case, the SGSN needs to initiate bearer deletion to the S-GW in step 24a.

If an lu connection exists between the SGSN and the UE, the SGSN releases the lu connection.

Step 24a: The SGSN sends a bearer deletion request to the S-GW, where the bearer deletion request may include a cause value indicating that the S-GW does not need to initiate bearer deletion to the P-GW or not include the cause value. The S-GW does not need to initiate bearer deletion to the P-GW, and returns a bearer deletion response to the SGSN.

Step 25: The SGSN returns a detachment indication ACK to the MME.

Step 26: The P-GW returns a bearer deletion response to the S-GW.

Step 27: The P-GW exchanges signaling messages with the PCRF.

Step 27 may be executed in certain conditions. The P-GW may notify the PCRF that all bearers to be deleted are already deleted.

Step 28: The S-GW returns a bearer deletion response to the MME.

Step 29: The UE returns a detachment Accept message to the MME.

Step 210: The signaling connections are released.

The signaling connections between the UE and the NodeB and between the NodeB and the MME are released.

The difference between the second embodiment and the first embodiment is that the MME triggers the detachment in the second embodiment. The process of triggering a detachment process by the SGSN is the same as the above process except for the following difference: The operations performed by the MME are performed by the SGSN and the operations performed by the SGSN are performed by the MME.

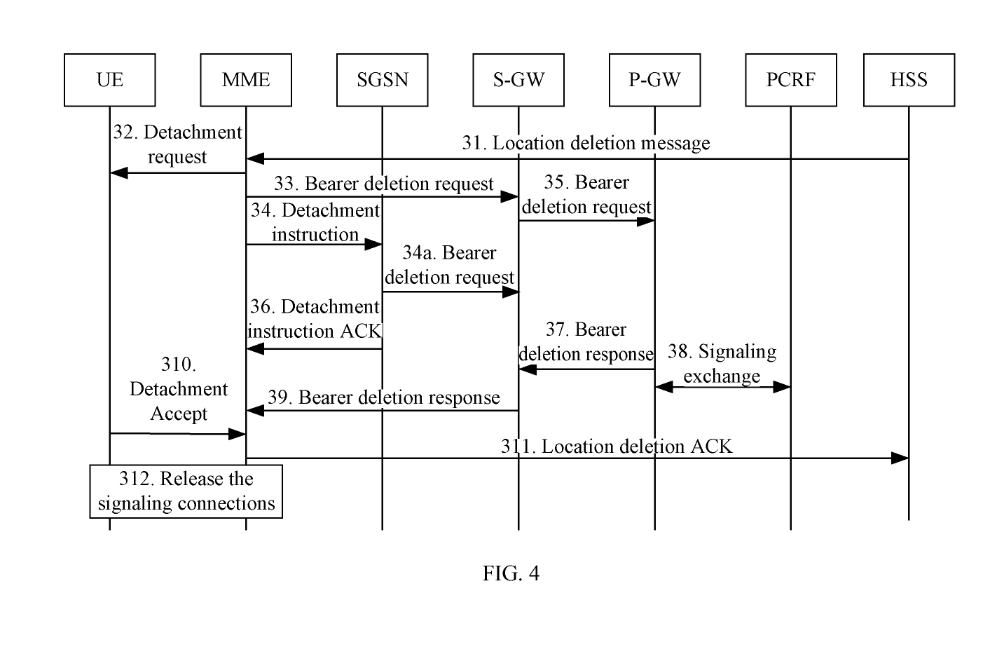

FIG. 4 is a flowchart of a method for detaching a UE according to the third embodiment of the present invention.

In the third embodiment, the HSS initiates complete detachment in case of double registration.

Step 31: The HSS sends a location deletion message to the MME, and instructs the MME to perform complete location deletion.

Step 32: After receiving the location deletion message from the HSS, the MME sends a detachment request to the UE.

Step 33: The MME sends a bearer deletion request to the S-GW, and instructs the S-GW to delete all the SM contexts.

In this step, if the bearer deletion request that the MME sends to the S-GW does not carry the indication, the S-GW deletes SAE-related SM contexts only.

Step 34: The MME sends a detachment indication that indicates complete detachment to the SGSN.

The detachment indication may carry some parameters to notify the SGSN that the detachment is initiated by the HSS.

The detachment indication may include a cause value indicating that the SGSN does not need to initiate bearer deletion to the S-GW. If the bearer deletion request that the MME sends to the S-GW does not carry the indication in step 33, the detachment indication may not include the cause value indicating that the SGSN does not need to initiate bearer deletion to the S-GW. In this case, the process goes to step 34a.

If an lu connection exists between the SGSN and the UE, the SGSN releases the lu connection.

Step 34a: The SGSN sends a bearer deletion request to the S-GW, where the bearer deletion request may include a cause value indicating that the S-GW does not need to initiate bearer deletion to the P-GW. The S-GW does not need to initiate bearer deletion to the P-GW, and returns a bearer deletion response to the SGSN.

Step 35: The S-GW initiates bearer deletion to the P-GW.

Step 36: The SGSN returns a detachment indication ACK to the MME.

Step 37: The P-GW returns a bearer deletion response to the S-GW.

Step 38: The P-GW exchanges signaling messages with the PCRF.

Step 38 may be executed in certain conditions. The P-GW may notify the PCRF that all bearers to be deleted are already deleted.

Step 39: The S-GW returns a bearer deletion response to the MME.

Step 310: The UE returns a detachment Accept message to the MME.

Step 311: The MME returns a location deletion ACK to the HSS.

Step 312: The signaling connections are released.

The signaling connections between the UE and the NodeB and between the NodeB and the MME are released.

The difference between the third embodiment and the second embodiment is that the HSS triggers the detachment in the third embodiment.

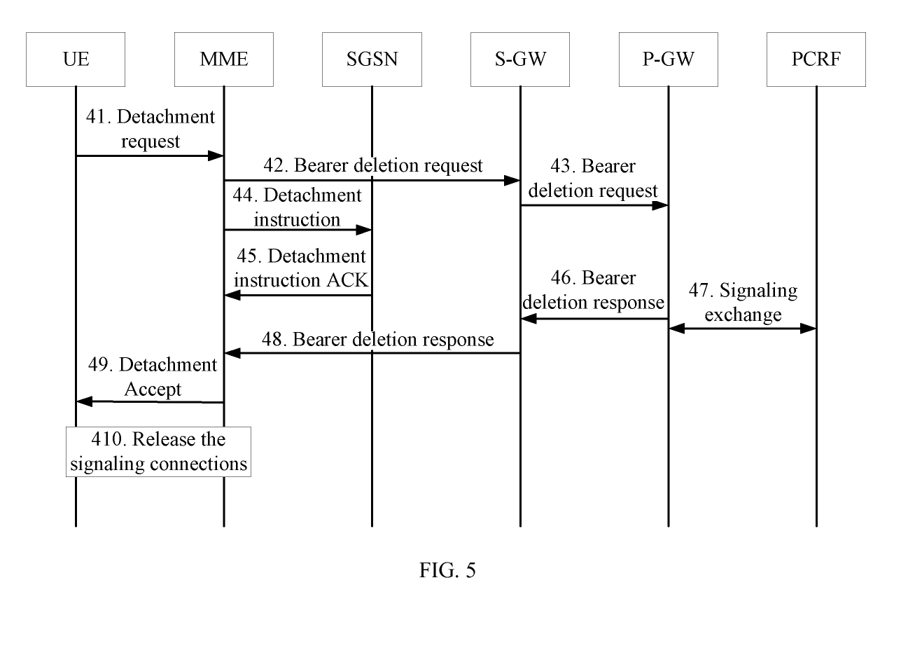

FIG. 5 is a flowchart of a method for detaching a UE according to the fourth embodiment of the present invention.

In the fourth embodiment, the MME registers with the HSS and the UE triggers complete detachment in the LTE network in case of single registration.

Step 41: The UE sends a detachment request that carries a complete detachment indication to the MME.

Step 42: After receiving the complete detachment request, the MME sends a bearer deletion request to the S-GW, and instructs the S-GW to delete all SM contexts.

Step 43: The S-GW initiates bearer deletion to the P-GW.

Step 44: The MME sends a detachment indication to the SGSN, where the detachment indication indicates complete detachment and may include a cause value indicating that the SGSN does not need to initiate bearer deletion to the S-GW.

If an lu connection exists between the SGSN and the UE, the SGSN releases the lu connection.

Step 45: The SGSN deletes UE-related MM contexts, and returns a detachment indication ACK to the MME.

Step 46: The P-GW returns a bearer deletion response to the S-GW.

Step 47: The P-GW exchanges signaling messages with the PCRF.

Step 47 may be executed in certain conditions. The P-GW may notify the PCRF that all bearers to be deleted are already deleted.

Step 48: The S-GW returns a bearer deletion response to the MME.

Step 49: The MME returns a detachment Accept message to the UE.

This step is executed only when the UE is not powered off.

Step 410: The signaling connections are released.

The signaling connections between the UE and the NodeB and between the NodeB and the MME are released.

If the bearer deletion request that the MME sends to the S-GW in step 42 does not carry the indication, the S-GW deletes SAE-related SM contexts only, and the detachment indication in step 44 does not include a cause value indicating that the SGSN does not need to initiate bearer deletion to the S-GW. The bearer deletion request that the SGSN sends to the S-GW may include a cause value indicating that the SGSN does not need to initiate bearer deletion to the P-GW. If the bearer deletion request does not include the cause value, the S-GW determines not to initiate bearer deletion to the P-GW. The S-GW returns a bearer response message to the SGSN. The difference between the fourth embodiment and the third embodiment is as follows: In the fourth embodiment, the UE initiates complete detachment to the MME in case of single registration (that is, only the MME registers with the HSS). The process of initiating complete detachment by the UE (only the SGSN registers with the HSS) in a 2G/3G network is the same as the above process except for the difference in the executor, and is not further described.

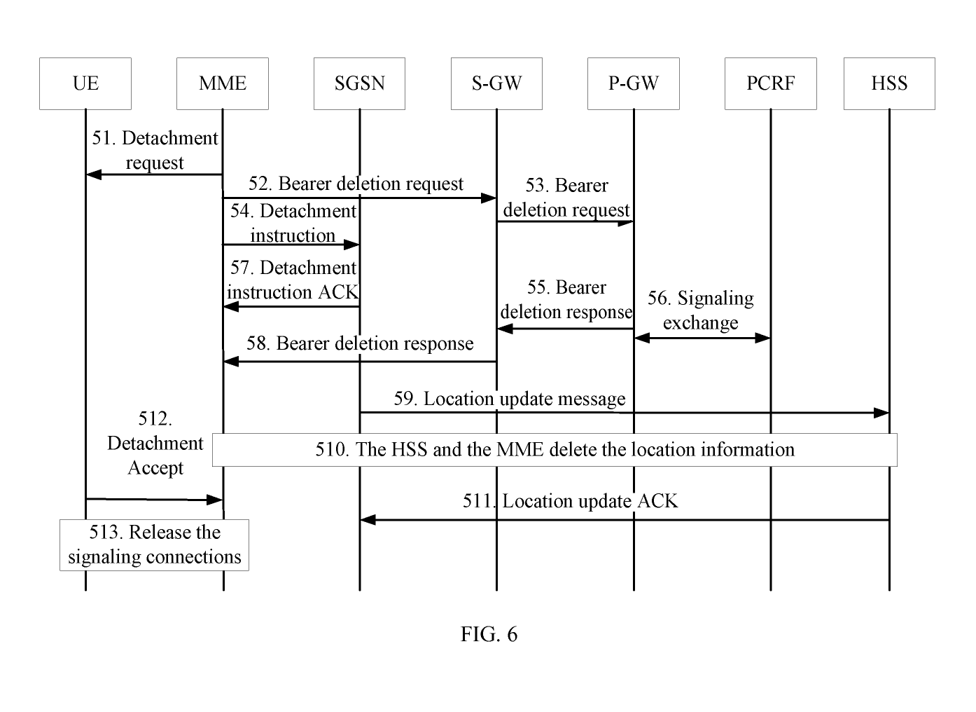

FIG. 6 is a flowchart of a method for detaching a UE according to the fifth embodiment of the present invention.

In the fifth embodiment, the MME registers with the HSS and the UE triggers complete detachment in the LTE network in case of single registration.

Step 51: The UE sends a detachment request that carries a complete detachment indication to the MME.

Step 52: After receiving the complete detachment request, the MME sends a bearer deletion request to the S-GW, and instructs the S-GW to delete all SM contexts.

Step 53: The S-GW initiates bearer deletion to the P-GW.

Step 54: The MME sends a detachment indication to the SGSN, where the detachment indication indicates complete detachment and may include a cause value indicating that the SGSN does not need to initiate bearer deletion to the S-GW.

If an lu connection exists between the SGSN and the UE, the SGSN releases the lu connection.

Step 55: The P-GW returns a bearer deletion response to the S-GW.

Step 56: The P-GW exchanges signaling messages with the PCRF.

Step 56 may be executed in certain conditions. The P-GW may notify the PCRF that all bearers to be deleted are already deleted.

Step 57: The SGSN returns a detachment ACK to the MME.

Step 58: The S-GW returns a bearer deletion response to the MME.

Step 59: The SGSN sends a location update message to the HSS.

Step 510: The HSS and the MME delete the location information.

The HSS deletes the information about the registered MME, and the MME deletes UE-related MM contexts.

Step 511: The HSS sends a location update ACK to the SGSN.

Step 512: The UE returns a detachment Accept message to the MME.

Step 513: The signaling connections are released.

The signaling connections between the UE and the NodeB and between the NodeB and the MME are released.

If the bearer deletion request that the MME sends to the S-GW in step 52 does not carry the indication, the S-GW deletes SAE-related SM contexts only, and the detachment indication in step 54 does not include a cause value indicating that the SGSN does not need to initiate bearer deletion to the S-GW. The bearer deletion request that the SGSN sends to the S-GW may include a cause value indicating that the SGSN does not need to initiate bearer deletion to the P-GW. If the bearer deletion request does not include the cause value, the S-GW determines not to initiate bearer deletion to the P-GW. The S-GW returns a bearer deletion response to the SGSN. The difference between the fifth embodiment and the fourth embodiment is as follows: In the fifth embodiment, steps of sending a location update message to the HSS by the SGSN and deleting the location information by the HSS and the MME are added. If only the SGSN registers with the HSS, the process of initiating complete detachment by the UE in a 2G/3G network is the same as the above process except for the difference in the executor, and is not further described.

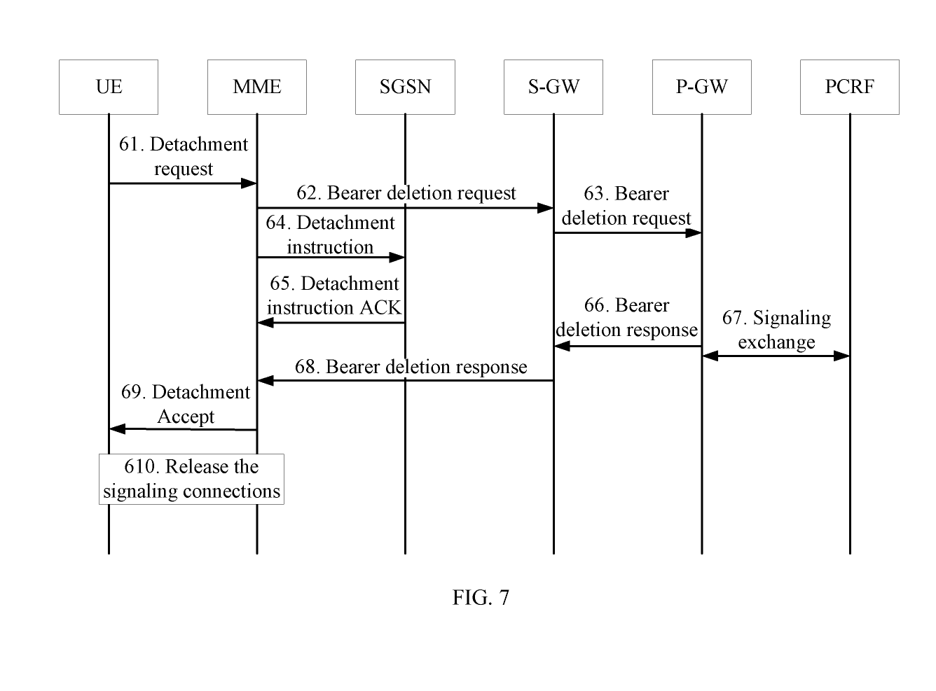

FIG. 7 is a flowchart of a method for detaching a UE according to the sixth embodiment of the present invention.

In the sixth embodiment, the SGSN registers with the HSS and the UE triggers complete detachment in the LTE network in case of single registration.

Step 61: The UE sends a detachment request that carries a complete detachment indication to the MME.

Step 62: After receiving the complete detachment request, the MME sends a bearer deletion request to the S-GW, and instructs the S-GW to delete all the SM contexts.

Step 63: The S-GW initiates bearer deletion to the P-GW.

Step 64: The MME deletes UE-related MM contexts stored in the MME, and sends a detachment indication to the SGSN, where the detachment indication indicates complete detachment and may include a cause value indicating that the SGSN does not need to initiate bearer deletion to the S-GW.

If an lu connection exists between the SGSN and the UE, the SGSN releases the lu connection.

Step 65: The SGSN returns a detachment indication ACK to the MME.

Step 66: The P-GW returns a bearer deletion response to the S-GW.

Step 67: The P-GW exchanges signaling messages with the PCRF.

Step 67 may be executed in certain conditions. The P-GW may notify the PCRF that all bearers to be deleted are already deleted.

Step 68: The S-GW returns a bearer deletion response to the MME.

Step 69: The MME returns a detachment Accept message to the UE.

Step 610: The signaling connections are released.

The signaling connections between the UE and the NodeB and between the NodeB and the MME are released.

If the bearer deletion request that the MME sends to the S-GW in step 62 does not carry the indication, the S-GW deletes SAE-related SM contexts only, and the detachment indication in step 64 does not include a cause value indicating that the SGSN does not need to initiate bearer deletion to the S-GW. The bearer deletion request that the SGSN sends to the S-GW may include a cause value indicating that the SGSN does not need to initiate bearer deletion to the P-GW. If the bearer deletion request does not include the cause value, the S-GW determines not to initiate bearer deletion to the P-GW. The S-GW returns a bearer deletion response to the SGSN. The process of initiating complete detachment by the UE (only the MME registers with the HSS) in a 2G/3G network is the same as the above process except for the difference in the executor, and is not further described.

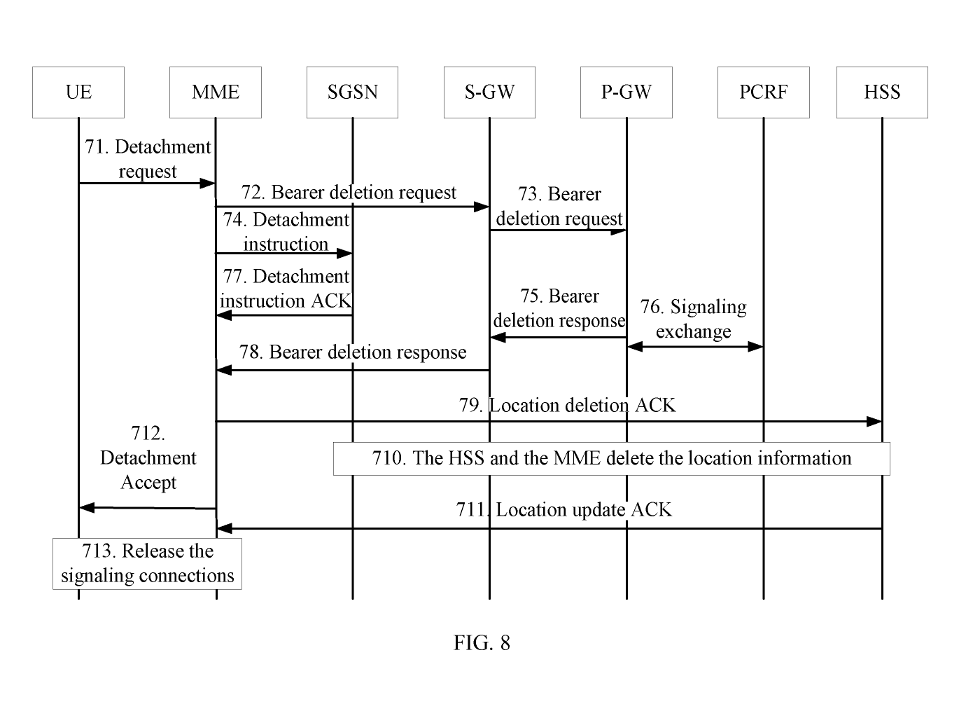

FIG. 8 is a flowchart of a method for detaching a UE according to the present invention.

In the seventh embodiment, the SGSN registers with the HSS and the UE triggers complete detachment in the LTE network in case of single registration.

Step 71: The UE sends a detachment request that carries a complete detachment indication to the MME.

Step 72: After receiving the complete detachment request, the MME sends a bearer deletion request to the S-GW, and instructs the S-GW to delete all the SM contexts.

Step 73: The S-GW initiates bearer deletion to the P-GW.

Step 74: The MME sends a detachment indication to the SGSN, where the detachment indication indicates complete detachment and may include a cause value indicating that the SGSN does not need to initiate bearer deletion to the S-GW.

If an lu connection exists between the SGSN and the UE, the SGSN releases the lu connection.

Step 75: The P-GW returns a bearer deletion response to the S-GW.

Step 76: The P-GW exchanges signaling messages with the PCRF.

Step 76 may be executed in certain conditions. The P-GW may notify the PCRF that all bearers to be deleted are already deleted.

Step 77: The SGSN returns a detachment ACK to the MME.

Step 78: The S-GW returns a bearer deletion response to the MME.

Step 79: The MME sends a location update message to the HSS.

Step 710: The HSS and the SGSN delete the location information.

The HSS deletes the registration information about the SGSN, and the SGSN deletes the UE-related MM contexts.

Step 711: The HSS sends a location update ACK to the MME.

Step 712: The MME returns a detachment Accept message to the UE.

Step 713: The signaling connections are released.

The signaling connections between the UE and the NodeB and between the NodeB and the MME are released.

If the bearer deletion request that the MME sends to the S-GW in step 72 does not carry the indication, the S-GW deletes SAE-related SM contexts only, and the detachment indication in step 74 does not include a cause value indicating that the SGSN does not need to initiate bearer deletion to the S-GW. The bearer deletion request that the SGSN sends to the S-GW may include a cause value indicating that the SGSN does not need to initiate bearer deletion to the P-GW. If the bearer deletion request does not include the cause value, the S-GW determines not to initiate bearer deletion to the P-GW. The S-GW returns a bearer deletion response to the SGSN. The process of initiating complete detachment by the UE (only the MME registers with the HSS) in a 2G/3G network is the same as the above process except for the difference in the executor, and is not further described. The difference between the seventh embodiment and the sixth embodiment is as follows: In the seventh embodiment, the step of sending a location update message to the HSS by the MME is added.

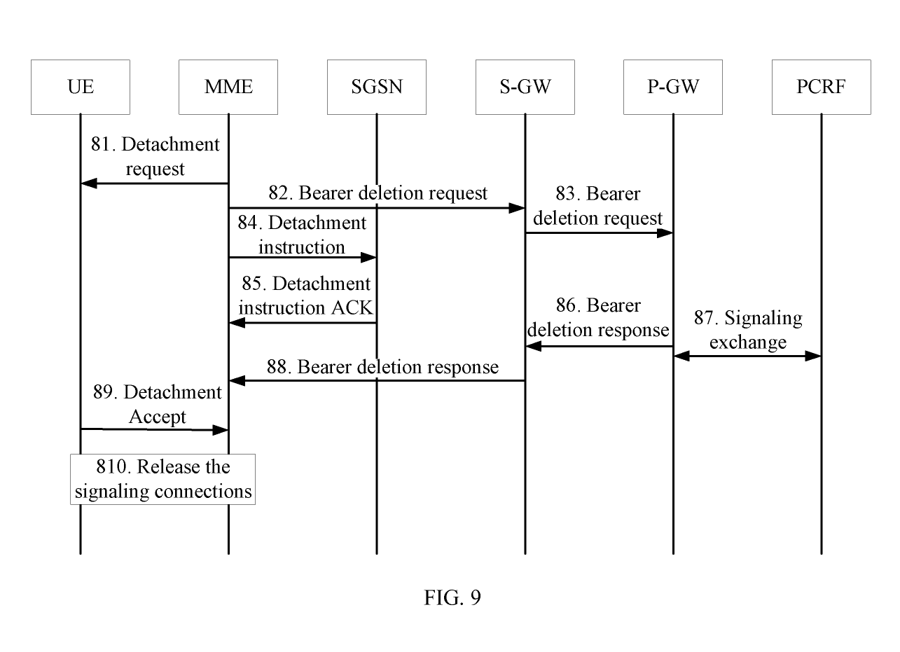

FIG. 9 is a flowchart of a method for detaching a UE according to the eighth embodiment of the present invention.

In the eighth embodiment, the MME registers with the HSS and the MME initiates complete detachment in the LTE network in case of single registration.

Step 81: The MME sends a detachment request that carries a complete detachment indication to the UE.

Step 82: The MME sends a bearer deletion request to the S-GW, and instructs the S-GW to delete all the SM contexts.

Step 83: The S-GW initiates bearer deletion to the P-GW.

Step 84: The MME sends a detachment indication to the SGSN, where the detachment indication indicates complete detachment and includes a cause value indicating that the SGSN does not need to initiate bearer deletion to the S-GW.

If an lu connection exists between the SGSN and the UE, the SGSN releases the lu connection.

Step 85: The SGSN deletes the MM contexts, and returns a detachment indication ACK to the MME.

Step 86: The P-GW returns a bearer deletion response to the S-GW.

Step 87: The P-GW exchanges signaling messages with the PCRF.

Step 87 may be executed in certain conditions. The P-GW may notify the PCRF that all bearers to be deleted are already deleted.

Step 88: The S-GW returns a bearer deletion response to the MME.

Step 89: The UE returns a detachment Accept message to the MME.

Step 810: The signaling connections are released.

The signaling connections between the UE and the NodeB and between the NodeB and the MME are released.

If the bearer deletion request that the MME sends to the S-GW in step 82 does not carry the indication, the S-GW deletes SAE-related SM contexts only, and the detachment indication in step 84 does not include a cause value indicating that the SGSN does not need to initiate bearer deletion to the S-GW. The bearer deletion request that the SGSN sends to the S-GW may include a cause value indicating that the SGSN does not need to initiate bearer deletion to the P-GW. If the bearer deletion request does not include the cause value, the S-GW determines not to initiate bearer deletion to the P-GW. The S-GW returns a bearer deletion response to the SGSN. The process of initiating complete detachment by the SGSN (only the SGSN registers with the HSS) in a 2G/3G network is the same as the above process except for the difference in the executor, and is not further described. The difference between the eighth embodiment and the second embodiment is as follows: In the eighth embodiment, the SGSN deletes all UE-related MM contexts because the SGSN does not register with the HSS; in the second embodiment, the SGSN deletes UE-related SM contexts only. The difference between the eighth embodiment and the fourth embodiment lies in the entity that triggers the detachment. That is, in the fourth embodiment, the UE triggers the detachment; in the eighth embodiment, the MME triggers the detachment.

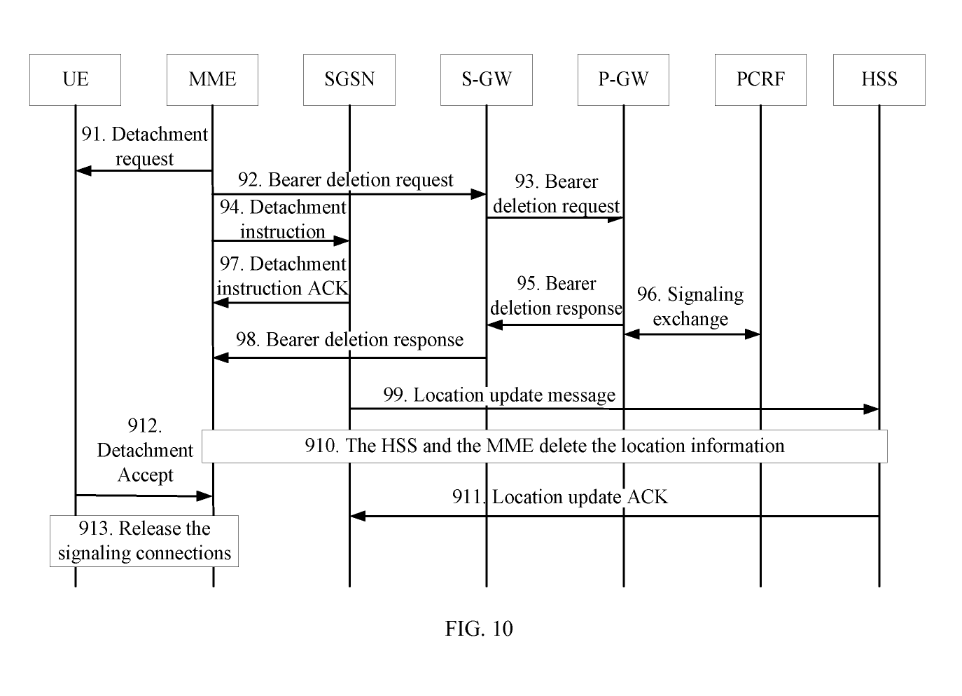

FIG. 10 is a flowchart of a method for detaching a UE according to the ninth embodiment of the present invention.

In the ninth embodiment, the MME registers with the HSS and the MME initiates complete detachment in the LTE network in case of single registration.

Step 91: The MME sends a detachment request that carries a complete detachment indication to the UE.

Step 92: The MME sends a bearer deletion request to the S-GW, and instructs the S-GW to delete all the SM contexts.

Step 93: The S-GW initiates bearer deletion to the P-GW.

Step 94: The MME sends a detachment indication to the SGSN, where the detachment indication indicates complete detachment and may include a cause value indicating that the SGSN does not need to initiate bearer deletion to the S-GW.

If an lu connection exists between the SGSN and the UE, the SGSN releases the lu connection.

Step 95: The P-GW returns a bearer deletion response to the S-GW.

Step 96: The P-GW exchanges signaling messages with the PCRF.

Step 96 may be executed in certain conditions. The P-GW may notify the PCRF that all bearers to be deleted are already deleted.

Step 97: The SGSN returns a detachment ACK to the MME.

Step 98: The S-GW returns a bearer deletion response to the MME.

Step 99: The SGSN determines that the SGSN does not register with the HSS, and sends a location update message to the HSS.

Step 910: The HSS and the MME delete the location information.

The HSS deletes the registration information about the MME, and the MME deletes UE-related MM contexts.

Step 911: The HSS sends a location update ACK to the SGSN.

Step 912: The UE returns a detachment Accept message to the MME.

Step 913: The signaling connections are released.

The signaling connections between the UE and the NodeB and between the NodeB and the MME are released.

If the bearer deletion request that the MME sends to the S-GW in step 92 does not carry the indication, the S-GW deletes SAE-related SM contexts only, and the detachment indication in step 94 does not include a cause value indicating that the SGSN does not need to initiate bearer deletion to the S-GW. The bearer deletion request that the SGSN sends to the S-GW may include a cause value indicating that the SGSN does not need to initiate bearer deletion to the P-GW. If the bearer deletion request does not carry the cause value, the S-GW determines not to initiate bearer deletion to the P-GW. The S-GW returns a bearer deletion response to the SGSN. The process of initiating complete detachment by the SGSN (only the SGSN registers with the HSS) in a 2G/3G network is the same as the above process except for the difference in the executor, and is not further described. The difference between the ninth embodiment and the eighth embodiment is as follows: In the ninth embodiment, the step of sending a location update message to the HSS by the SGSN is added. The difference between the ninth embodiment and the fifth embodiment is as follows: In the ninth embodiment, the MME triggers the detachment; in the fifth embodiment, the UE triggers the detachment.

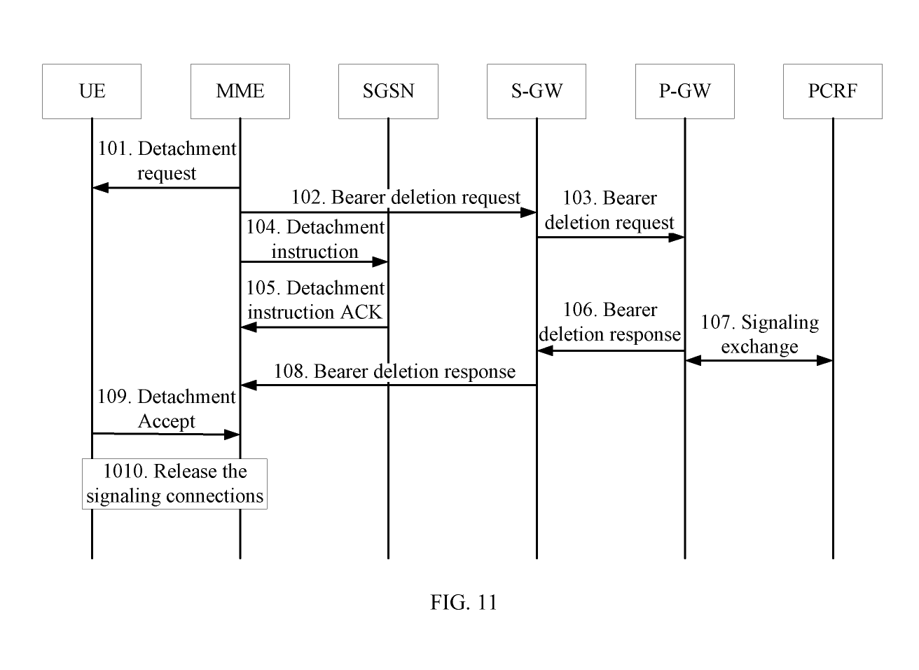

FIG. 11 is a flowchart of a method for detaching a UE according to the tenth embodiment of the present invention.

In the tenth embodiment, the SGSN registers with the HSS and the MME initiates complete detachment in the LTE network in case of single registration.

Step 101: The MME sends a detachment request that carries a complete detachment indication to the UE.

Step 102: The MME sends a bearer deletion request to the S-GW, and instructs the S-GW to delete all the SM contexts.

Step 103: The S-GW initiates bearer deletion to the P-GW.

Step 104: The MME deletes UE-related MM contexts stored in the MME, and sends a detachment indication to the SGSN, where the detachment indication indicates complete detachment and may include a cause value indicating that the SGSN does not need to initiate bearer deletion to the S-GW.

If an lu connection exists between the SGSN and the UE, the SGSN releases the lu connection.

Step 105: The SGSN returns a detachment indication ACK to the MME.

Step 106: The P-GW returns a bearer deletion response to the S-GW.

Step 107: The P-GW exchanges signaling messages with the PCRF.

Step 107 may be executed in certain conditions. The P-GW may notify the PCRF that all bearers to be deleted are already deleted.

Step 108: The S-GW returns a bearer deletion response to the MME.

Step 109: The UE returns a detachment Accept message to the MME.

Step 1010: The signaling connections are released.

The signaling connections between the UE and the NodeB and between the NodeB and the MME are released.

If the bearer deletion request that the MME sends to the S-GW in step 102 does not carry the indication, the S-GW deletes SAE-related SM contexts only, and the detachment indication in step 104 does not include a cause value indicating that the SGSN does not need to initiate bearer deletion to the S-GW. The bearer deletion request that the SGSN sends to the S-GW may include a cause value indicating that the SGSN does not need to initiate bearer deletion to the P-GW. If the bearer deletion request does not include the cause value, the S-GW determines not to initiate bearer deletion to the P-GW. The S-GW returns a bearer deletion response to the SGSN. The process of initiating complete detachment by the SGSN (only the MME registers with the HSS) in a 2G/3G network is the same as the above process except for the difference in the executor, and is not further described. The difference between the tenth embodiment and the sixth embodiment is as follows: In the tenth embodiment, the MME initiates the detachment request; in the sixth embodiment, the UE initiates the detachment request.

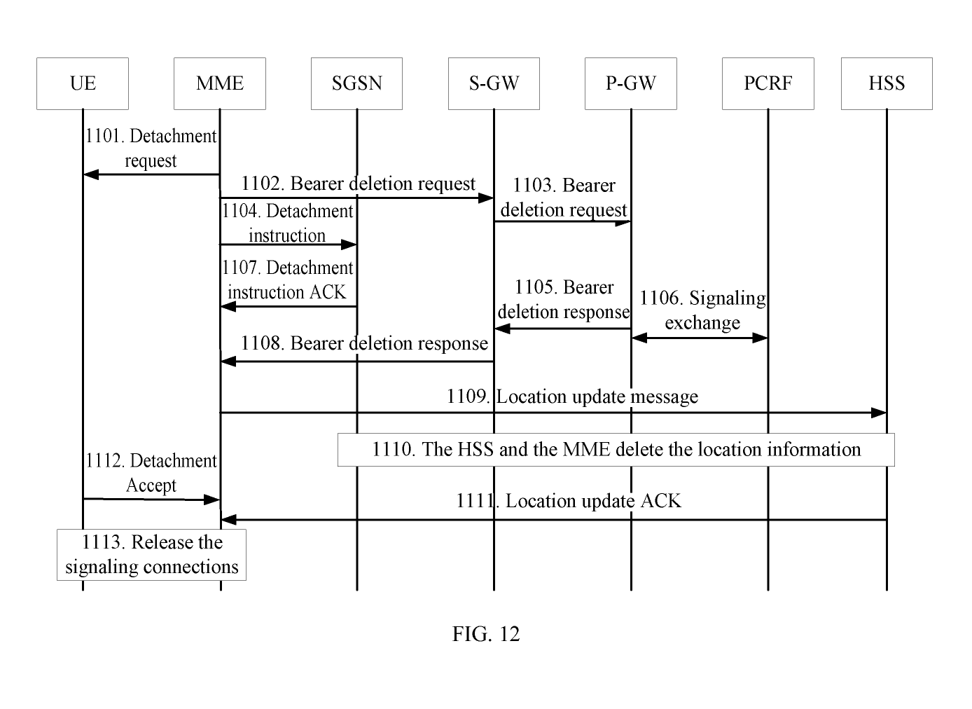

FIG. 12 is a flowchart of a method for detaching a UE according to the eleventh embodiment of the present invention.

In the eleventh embodiment, the SGSN registers with the HSS and the MME initiates complete detachment in the LTE network in case of single registration.

Step 1101: The MME sends a detachment request that carries a complete detachment indication to the UE.

Step 1102: The MME sends a bearer deletion request to the S-GW, and instructs the S-GW to delete all the SM contexts.

Step 1103: The S-GW initiates bearer deletion to the P-GW.

Step 1104: The MME sends a detachment indication to the SGSN, where the detachment indication indicates complete detachment and may include a cause value indicating that the SGSN does not need to initiate bearer deletion to the S-GW.

If an lu connection exists between the SGSN and the UE, the SGSN releases the lu connection.

Step 1105: The P-GW returns a bearer deletion response to the S-GW.

Step 1106: The P-GW exchanges signaling messages with the PCRF.

Step 1106 may be executed in certain conditions. The P-GW may notify the PCRF that all bearers to be deleted are already deleted.

Step 1107: The SGSN returns a detachment ACK to the MME.

Step 1108: The S-GW returns a bearer deletion response to the MME.

Step 1109: The MME sends a location update message to the HSS.

Step 1110: The HSS and the SGSN delete the location information.

The HSS deletes the registration information about the SGSN, and the SGSN deletes the UE-related MM contexts.

Step 1111: The HSS sends a location update ACK to the MME.

Step 1112: The UE returns a detachment Accept message to the MME.

Step 1113: The signaling connections are released.

The signaling connections between the UE and the NodeB and between the NodeB and the MME are released.

If the bearer deletion request that the MME sends to the S-GW in step 1102 does not carry the indication, the S-GW deletes SAE-related SM contexts only, and the detachment indication in step 1104 does not include a cause value indicating that the SGSN does not need to initiate bearer deletion to the S-GW. The bearer deletion request that the SGSN sends to the S-GW may include a cause value indicating that the SGSN does not need to initiate bearer deletion to the P-GW. If the bearer deletion request does not include the cause value, the S-GW determines not to initiate bearer deletion to the P-GW. The S-GW returns a bearer deletion response to the SGSN. The process of initiating complete detachment by the SGSN (only the MME registers with the HSS) in a 2G/3G network is the same as the above process except for the difference in the executor, and is not further described. The difference between the eleventh embodiment and the seventh embodiment is as follows: In the seventh embodiment, the UE initiates the detachment request. The difference between the eleventh embodiment and the tenth embodiment is as follows: In the eleventh embodiment, the step of sending a location update message to the HSS by the MME is added.

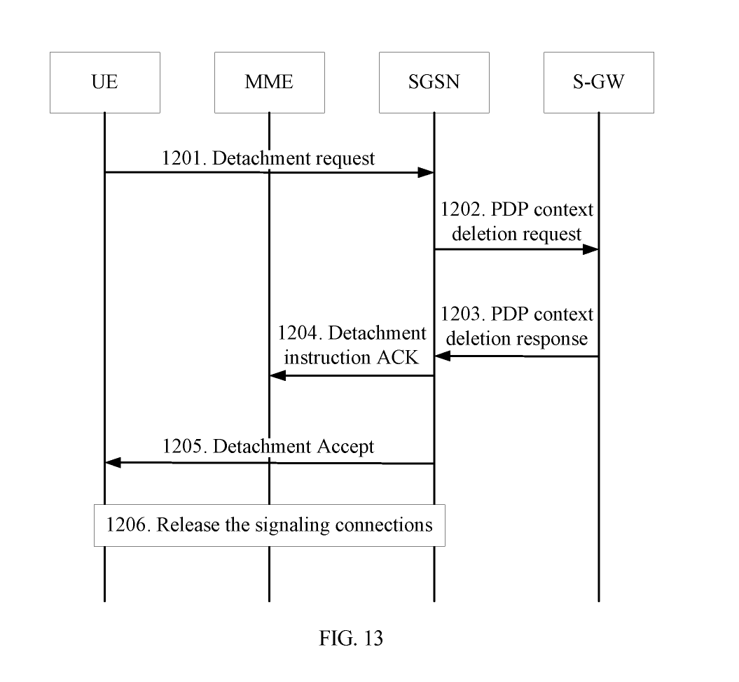

FIG. 13 is a flowchart of a method for detaching a UE according to the twelfth embodiment of the present invention.

In this embodiment, the UE initiates single detachment in a 2G/3G network to detach the UE from only the SGSN in case of double registration.

Step 1201: The UE sends a detachment request to the SGSN, indicating that the UE needs to be detached from only the 2G/3G network.

Step 1202: After receiving the detachment request, the SGSN sends a Packet Data Protocol (PDP) context deletion request to the S-GW, where the PDP context deletion request may carry a cause value indicating that the S-GW does not need to initiate bearer deletion to the P-GW, or not include the cause value.

Step 1203: The S-GW sends a PDP context deletion response to the SGSN.

Step 1204: The SGSN sends a detachment indication that carries the type of detachment request to the MME, notifying the MME that the SGSN already detaches the UE.

Step 1205: The SGSN returns a detachment Accept message to the UE.

This step is executed only when the UE is not powered off.

Step 1206: The signaling connections are released.

The signaling connections between the UE and the NodeB and between the NodeB and the SGSN are released.

The process of initiating MME detachment by the UE in the LTE network in case of double registration is the same as the above process except for the difference in the executor, and is not further described.

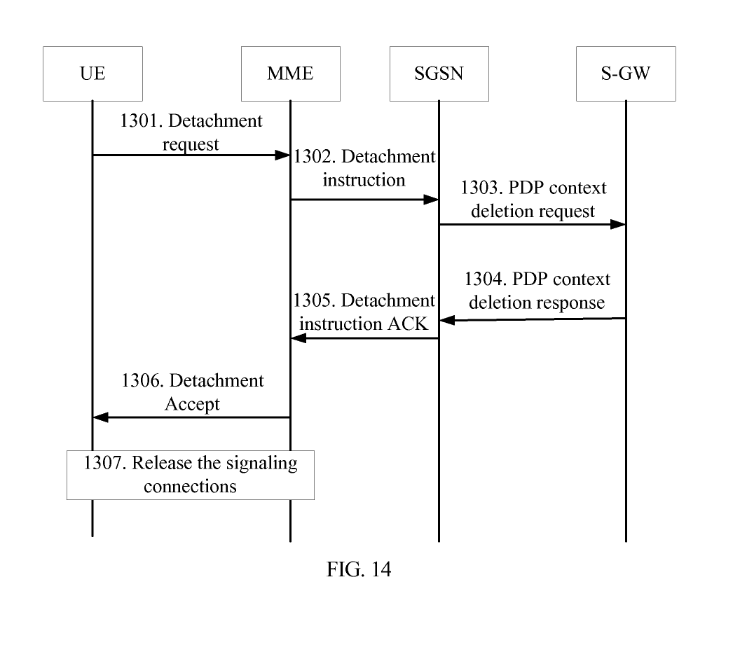

FIG. 14 is a flowchart of a method for detaching a UE according to the thirteenth embodiment of the present invention.

In this embodiment, the UE initiates single detachment in the LTE network to detach the UE from only the SGSN in case of double registration.

Step 1301: The UE sends a detachment request to the MME, indicating that the UE needs to be detached from only the 2G/3G network.

Step 1302: The MME sends a detachment indication to the SGSN, indicating that the UE needs to be detached from only the 2G/3G network.

Step 1303: After receiving the detachment request, the SGSN sends a PDP context deletion request to the S-GW, where the PDP context deletion request may carry a cause value indicating that the S-GW does not need to initiate bearer deletion to the P-GW, or not include the cause value.

Step 1304: The S-GW sends a PDP context deletion response to the SGSN.

Step 1305: The SGSN sends a detachment indication ACK that carries the type of detachment request to the MME, notifying the MME that the SGSN already detaches the UE.

Step 1306: The MME returns a detachment Accept message to the UE.

This step is executed only when the UE is not powered off.

Step 1307: The signaling connections are released.

The signaling connections between the UE and the NodeB and between the NodeB and the SGSN are released.

The difference between the thirteenth embodiment and the twelfth embodiment is as follows: In the twelfth embodiment, the UE sends a detachment request to the SGSN; in the thirteenth embodiment, the UE sends a detachment request to the MME, and the MME sends a detachment indication to the SGSN. The process of initiating MME detachment to the SGSN by the UE in case of double registration is similar to the above process, and is not further described.

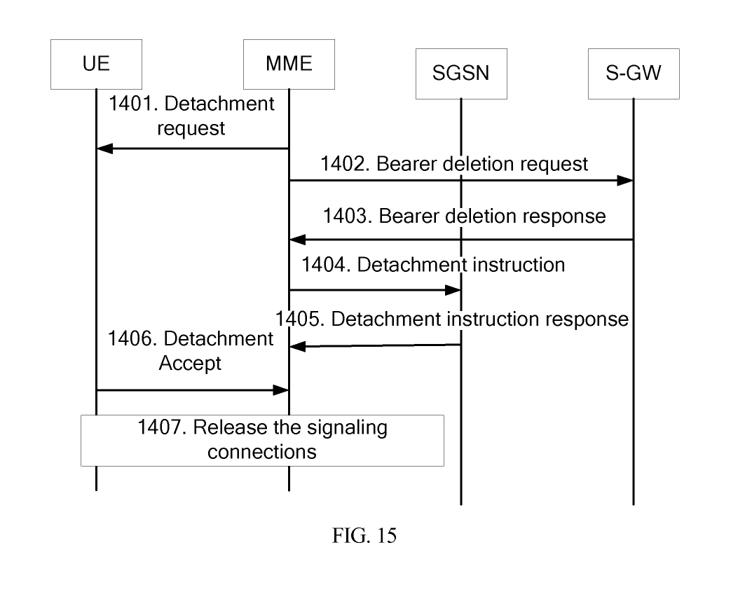

FIG. 15 is a flowchart of a method for detaching a UE according to the fourteenth embodiment of the present invention.

In this embodiment, the MME initiates a process of detaching the UE from only the MME in the LTE network in case of double registration. If the HSS initiates the process, step 1401a needs to be added before step 1401; that is, the HSS sends location deletion information the MME.

Step 1401: The MME sends a detachment request to the UE, indicating that the UE needs to be detached from only the SAE network.

Step 1402: The MME sends a bearer deletion request to the S-GW, where the bearer deletion request may carry a cause value indicating that the S-GW does not need to initiate bearer deletion to the P-GW, or not include the cause value.

Step 1403: The S-GW sends a bearer deletion response to the MME.

Step 1404: The MME sends a detachment indication to the SGSN, indicating that the UE needs to be detached from only the SAE network, and notifying the SGSN that the MME already detaches the UE.

Step 1405: The SGSN sends a detachment indication response to the MME.

Step 1406: The UE returns a detachment Accept message to the MME.

Step 1407: The signaling connections are released.

The signaling connections between the UE and the MME and between the MME and the NodeB are released.

The process of initiating SGSN detachment by the SGSN in case of double registration is similar to the above process, and is not further described.

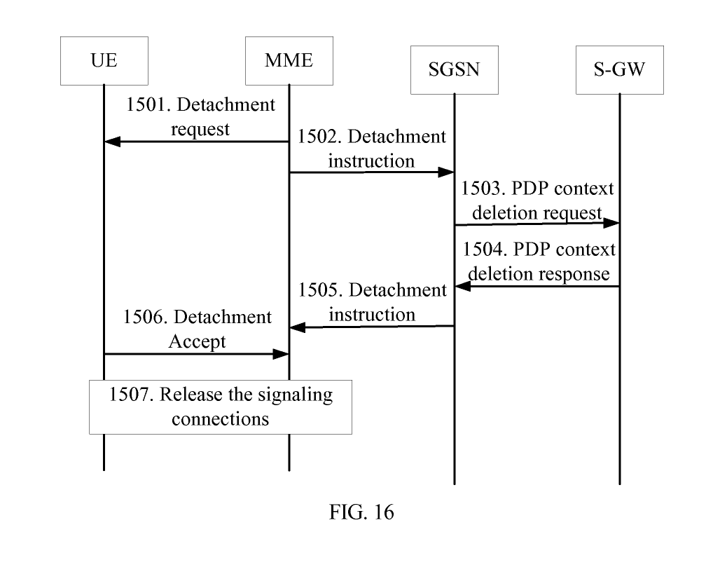

FIG. 16 is a flowchart of a method for detaching a UE according to the fifteenth embodiment of the present invention.

In this embodiment, the MME initiates a process of detaching the UE from only the SGSN in the LTE network in case of double registration.

Step 1501: The MME sends a detachment request to the UE, indicating that the UE needs to be detached from only the 2G/3G network.

Step 1502: The MME sends a detachment indication to the SGSN, indicating that the UE needs to be detached from only the 2G/3G network.

Step 1503: After receiving the detachment request, the SGSN sends a PDP context deletion request to the S-GW, where the PDP context deletion request may carry a cause value indicating that the S-GW does not need to initiate bearer deletion to the P-GW, or not include the cause value. If the PDP context deletion request does not include the cause value, the S-GW determines not to initiate bearer deletion to the P-GW.

Step 1504: The S-GW sends a PDP context deletion response to the SGSN.

Step 1505: The SGSN sends a detachment indication ACK that carries the type of detachment request to the MME, notifying the MME that the SGSN already detaches the UE.

Step 1506: The UE returns a detachment Accept message to the MME.

Step 1507: The signaling connections are released.

The signaling connections between the UE and the NodeB and between the NodeB and the MME are released.

The process of initiating MME detachment by the SGSN in case of double registration is similar to the above process, and is not further described. The difference between the fifteenth embodiment and the thirteenth embodiment is that the detachment of the UE from the SGSN is initiated by the MME in the fifteenth embodiment.

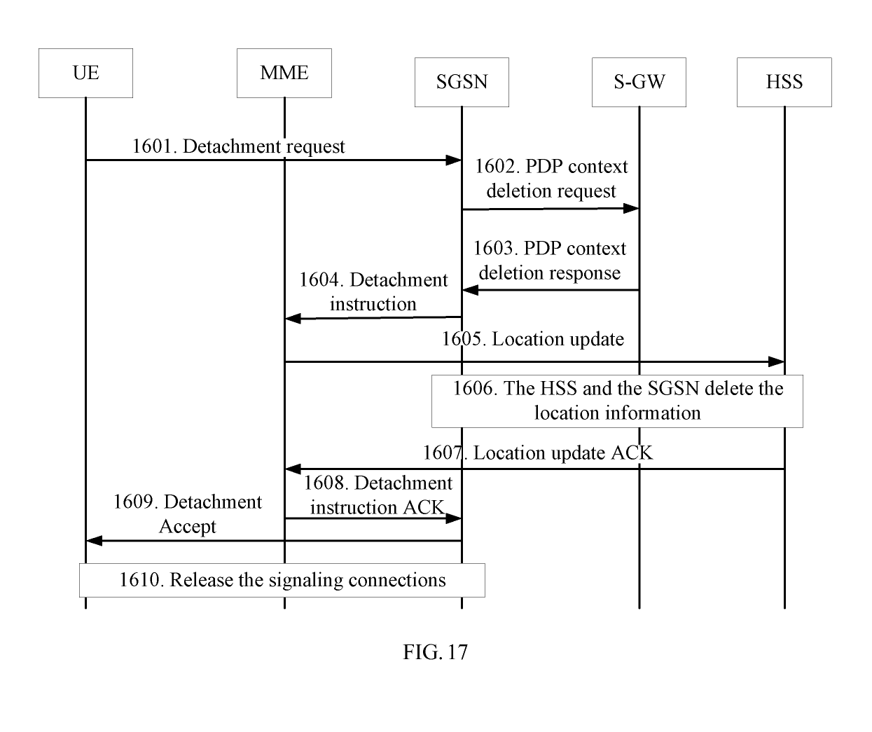

FIG. 17 is a flowchart of a method for detaching a UE according to the sixteenth embodiment of the present invention.

In this embodiment, the SGSN registers with the HSS and the UE initiates a process of detaching the UE from only the SGSN in a 2G/3G network in case of single registration.

Step 1601: The UE sends a detachment request to the SGSN, indicating that the UE needs to be detached from only the 2G/3G network.

Step 1602: After receiving the detachment request, the SGSN sends a PDP context deletion request to the S-GW, where the PDP context deletion request may carry a cause value indicating that the S-GW does not need to initiate bearer deletion to the P-GW, or not include the cause value. If the PDP context deletion request does not include the cause value, the S-GW determines not to initiate bearer deletion to the P-GW.

Step 1603: The S-GW sends a PDP context deletion response to the SGSN.

Step 1604: The SGSN sends a detachment indication that carries the type of detachment request to the MME, notifying the MME that the SGSN already detaches the UE.

Step 1605: The MME sends a location update message to the HSS, and registers with the HSS.

Step 1606: The HSS and the SGSN delete the location information.

The HSS deletes the registration information about the SGSN, and the SGSN deletes the UE-related context information.

Step 1607: The HSS sends a location update ACK to the MME.

Step 1608: The MME sends a detachment indication ACK to the SGSN.

Step 1609: The SGSN returns a detachment Accept message to the UE.

This step is executed only when the UE is not powered off.

Step 1610: The signaling connections are released.

The signaling connections between the UE and the NodeB and between the NodeB and the SGSN are released.

The process of initiating MME detachment in the LTE network in case of single registration (only the MME registers with the HSS) is similar to the above process, and is not further described. The difference between the sixteenth embodiment and the fifteenth embodiment is as follows: In the sixteenth embodiment, the MME needs to register with the HSS after the UE is detached from the SGSN. In the above process, if the MME registers with the HSS under the same condition, the SGSN deletes UE-related MM contexts before step 1604, that is, before the SGSN sends a detachment indication to the MME, and step 1605 to step 1607 are not required.

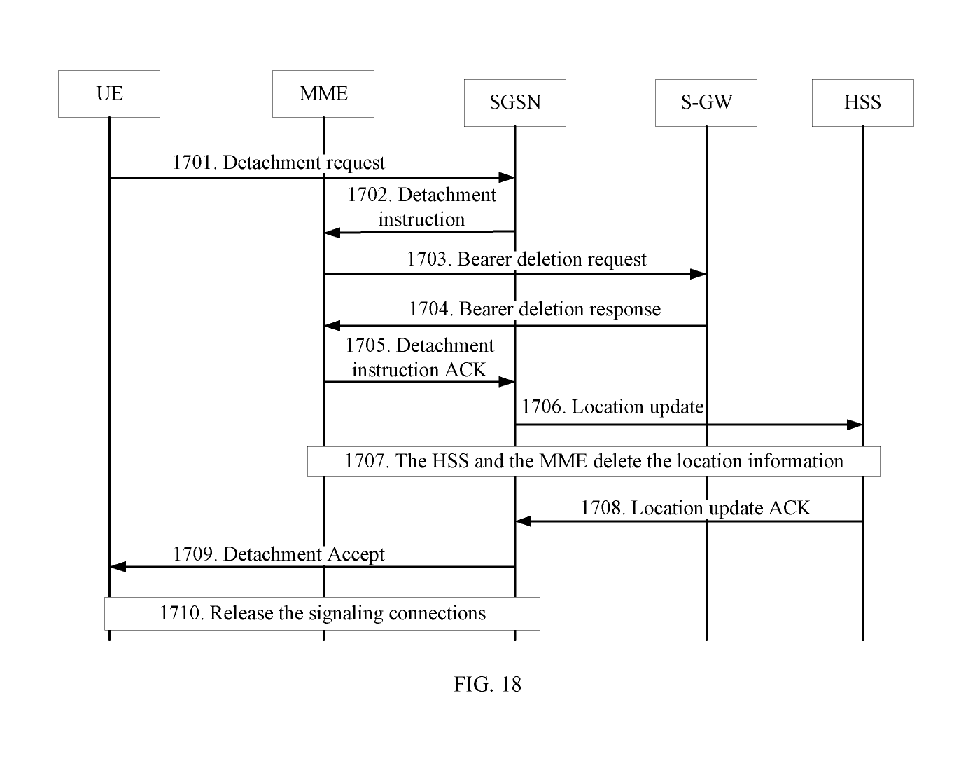

FIG. 18 is a flowchart of a method for detaching a UE according to the seventeenth embodiment of the present invention.

In this embodiment, the MME registers with the HSS and the UE initiates a process of detaching the UE from only the MME in a 2G/3G network in case of single registration.

Step 1701: The UE sends a detachment request to the SGSN, indicating that the UE needs to be detached from only the SAE network.

Step 1702: The SGSN sends a detachment indication to the MME, indicating that the UE needs to be detached from only the SAE network.

Step 1703: The MME sends a bearer deletion request to the S-GW, where the bearer deletion request may carry a cause value indicating that the S-GW does not need to initiate bearer deletion to the P-GW, or not include the cause value. If the bearer deletion request does not include the cause value, the S-GW determines not to initiate bearer deletion to the P-GW.

Step 1704: The S-GW sends a bearer deletion response to the MME.

Step 1705: The MME sends a detachment indication ACK to the SGSN, notifying the SGSN that the MME already detaches the UE.

Step 1706: The SGSN sends a location update message to the HSS, and registers with the HSS.

Step 1707: The HSS and the MME delete the location information.

The HSS deletes the registration information about the MME, and the MME deletes the UE-related MM contexts.

Step 1708: The HSS sends a location update ACK to the SGSN.

Step 1709: The SGSN returns a detachment Accept message to the UE.

This step is executed only when the UE is not powered off.

Step 1710: The signaling connections are released.

The signaling connections between the UE and the NodeB and between the NodeB and the SGSN are released.

The process of initiating SGSN detachment by the UE in the LTE network in case of single registration (only the SGSN registers with the HSS) is similar to the above process, and is not further described. In this embodiment, if the SGSN registers with the HSS under the same conditions, and the MME deletes UE-related MM context information in step 1705, but step 1706 to step 1708 are not required.

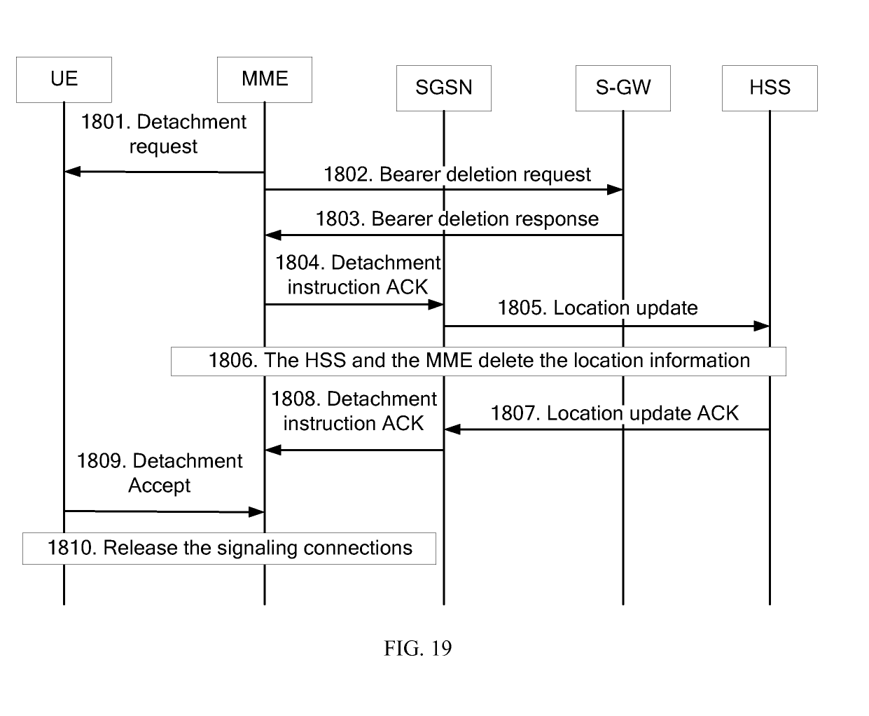

FIG. 19 is a flowchart of a method for detaching a UE according to the eighteenth embodiment of the present invention.

In the eighteenth embodiment, the MME registers with the HSS and the MME initiates a process of detaching the UE from the MME in the LTE in case of single registration.

Step 1801: The MME sends a detachment request to the UE, indicating that the UE needs to be detached from only the SAE network.

Step 1802: The MME sends a bearer deletion request to the S-GW, where the bearer deletion request may carry a cause value indicating that the S-GW does not need to initiate bearer deletion to the P-GW, or not include the cause value. If the bearer deletion request does not include the cause value, the S-GW determines not to initiate bearer deletion to the P-GW.

Step 1803: The S-GW sends a bearer deletion response to the MME.

Step 1804: The MME sends a detachment indication that carries a detachment type parameter to the MME, notifying the SGSN that the MME already detaches the UE.

Step 1805: The SGSN sends a location update message to the HSS, and registers with the HSS.

Step 1806: The HSS and the MME delete the location information.

The HSS deletes the registration information about the SGSN, and the SGSN deletes the UE-related context information.

Step 1807: The HSS sends a location update ACK to the SGSN.

Step 1808: The SGSN sends a detachment indication ACK to the MME.

Step 1809: The UE returns a detachment Accept message to the MME.

Step 1810: The signaling connections are released.

The signaling connections between the UE and the NodeB and between the NodeB and the MME are released.

In this embodiment, if the SGSN registers with the HSS under the same conditions, and the MME deletes UE-related MM contexts in step 1804, but step 1805 to step 1807 are not required. The process of initiating SGSN detachment by the SGSN in the 2G/3G network in case of single registration (the SGSN registers with the HSS) is similar to the above process, and is not further described.

In conclusion, in case of single registration, the following rule should be complied with when the detachment is single detachment: If the SGSN registers with the HSS, to detach the UE from the MME, the SGSN only needs to delete the UE-related MM contexts in the MME; to detach the UE from the SGSN, the MME needs to update the registration information in the HSS to register with the HSS. If the MME registers with the HSS, to detach the UE from the MME, the SGSN needs to update the registration information in the HSS; to detach the UE from the SGSN, the MME only needs to delete all the UE-related MM contexts in the SGSN.

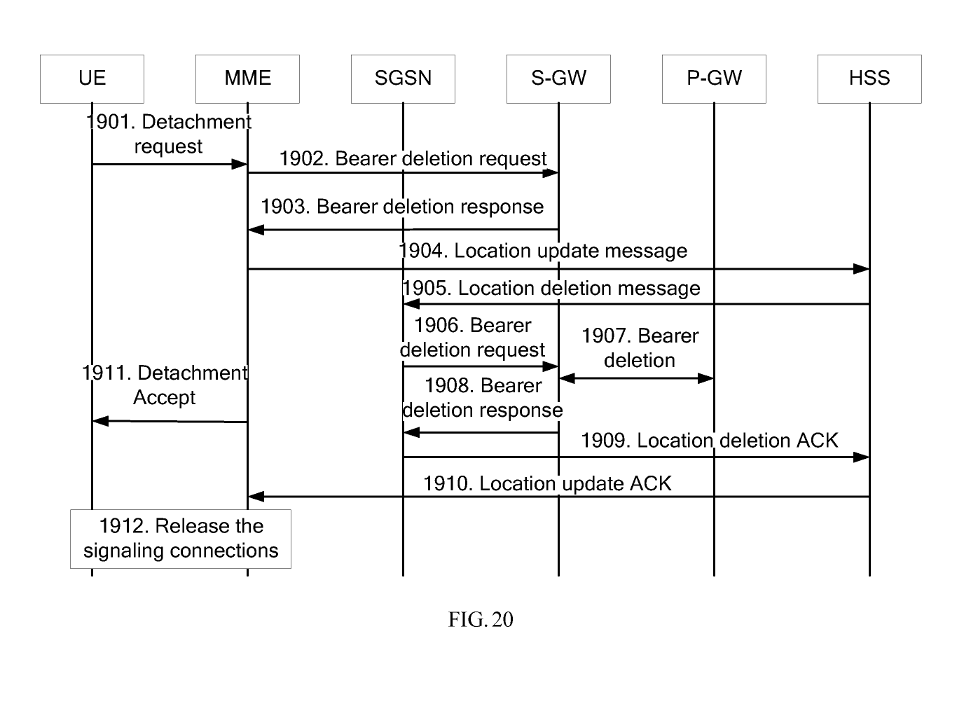

FIG. 20 is a flowchart of a method for detaching a UE according to the nineteenth embodiment of the present invention.

The preceding first embodiment to the eleventh embodiment describe complete detachment of the UE. In the complete detachment method, the UE detachment operation of a first network access control entity is triggered; the first network access control entity notifies a second network access control entity of performing the complete detachment. The nineteenth embodiment provides a notification method different from that provided in the preceding embodiments; and the S-GW initiates bearer deletion to the P-GW in case of complete detachment. In addition, the execution sequence in the nineteenth embodiment is different from those in the first embodiment to the eleventh embodiment. In the nineteenth embodiment, the S-GW initiates bearer deletion to the P-GW after deleting the bearers of the first network access control entity and the second network access control entity. This execution sequence is also applicable to the first embodiment to the eleventh embodiment.

Step 1901: The UE sends a detachment request that carries a complete detachment indication to the MME.

In this step, the detachment operation of the first network access control entity, that is MME, is triggered. The MME may also initiate the complete detachment operation, or the HSS sends a location deletion message that includes a complete detachment indication to the MME to trigger the complete detachment operation of the MME.

Step 1902: The MME sends a bearer deletion request to the S-GW.

In this step, the first network access control entity, that is MME, sends a bearer deletion request to the S-GW, and the S-GW deletes MME-related bearer information.

Step 1903: The S-GW returns a bearer deletion response to the MME.

The S-GW returns a bearer deletion response to the first network access control entity, that is MME.

Step 1904: The MME sends a location update message to the HSS.

The location update message carries an indication for deactivating signaling reduction, a special cause value, a special value indicating the update type, or other indication parameters.

Step 1905: The HSS sends a location deletion message to the SGSN.

The location deletion message carries an indication for deactivating signaling reduction, a special cause value, a special value indicating the deletion type, or other indication parameters.

Step 1906: The SGSN sends a bearer deletion request to the S-GW.

In this step, the second network access control entity sends a bearer deletion request to the S-GW, where the bearer deletion request is a PDP context deletion request; and the S-GW deletes the bearer information related to the UE and the SGSN.

Step 1907: The S-GW initiates bearer deletion to the P-GW.

After deleting the bearer information about the MME and the SGSN, the S-GW initiates bearer deletion to the P-GW.

Step 1908: The S-GW returns a bearer deletion response to the SGSN.

Step 1909: The SGSN returns a location deletion ACK to the HSS.

Step 1910: The HSS returns a location update ACK to the MME.

Step 1911: The MME returns a detachment Accept message to the UE.

If the detachment request indicates that the UE needs to be detached in case of non power-off, this step is executed; otherwise this step is omitted.

Step 1912: The signaling connections are released.

The signaling connections between the UE and the NodeB and between the NodeB and the MME are released.

This embodiment is based on the fact that the UE initiates complete detachment. In this embodiment, the first network access control entity notifies the second network access control entity of performing complete detachment through the HSS. This notification method is different from that in the first embodiment to the eleventh embodiment, but is also applicable to the first embodiment to the eleventh embodiment. The complete detachment initiated by the UE in the 2G/3G network in case of signaling reduction is similar to the preceding method except for the difference in the systems and message names, and is not further described.

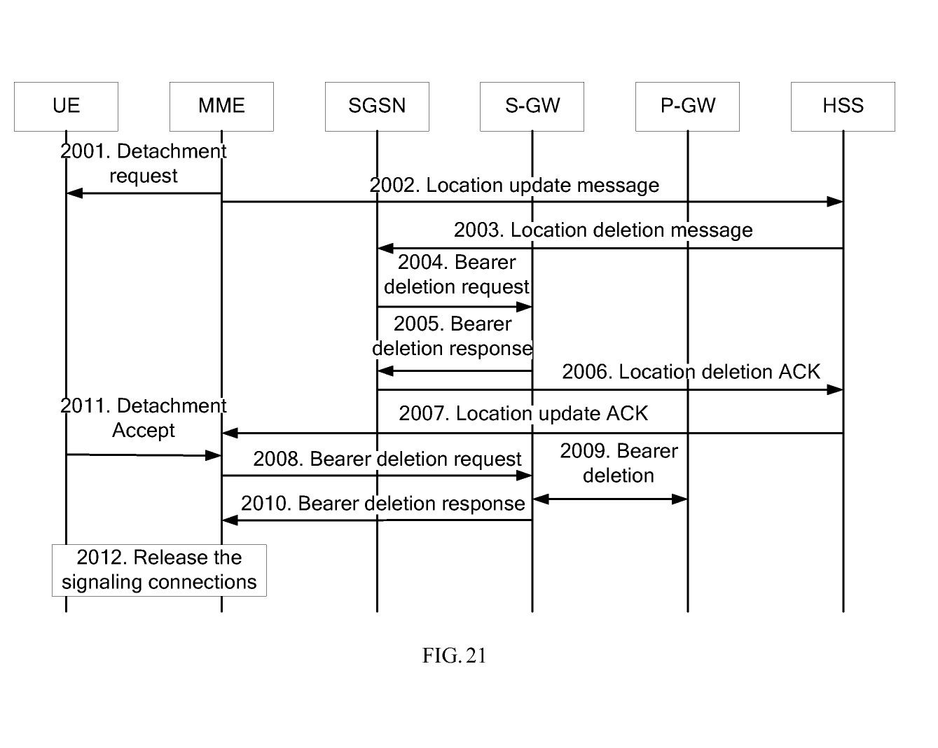

FIG. 21 is a flowchart of a method for detaching a UE according to the twentieth embodiment of the present invention.

In this embodiment, a first network access control entity notifies a second network access control entity in case of complete detachment. The notification method used in this embodiment is the same as that in the nineteenth embodiment except for the following difference: In this embodiment, the first network access control entity notifies the second network access control entity first, and then detaches the UE from the first network access control entity; after the first network access control entity detaches the UE, the S-GW initiates bearer deletion to the P-GW.

Step 2001: The MME sends a detachment request that carries a complete detachment indication to the MME.

In this step, the detachment operation of the first network access control entity is triggered. The MME may initiate the complete detachment operation, or the HSS sends a location deletion message that includes a complete detachment operation indication to the MME to trigger the complete detachment operation of the MME. The detachment request may carry a detachment type parameter indicating whether the UE is reattached. If the message carries a parameter indicating that the UE is reattached, step 2012 is omitted.

Step 2002: The MME sends a location update message to the HSS.

The location update message carries an indication for deactivating signaling reduction, a special cause value, a special value indicating the update type, or other indication parameters.

Step 2003: The HSS sends a location deletion message to the SGSN.

The location deletion message carries an indication for deactivating signaling reduction, a special cause value, a special value indicating the deletion type, or other indication parameters.

Step 2004: The SGSN sends a bearer deletion request to the S-GW.

In this step, the second network access control entity sends a bearer deletion request to the S-GW, where the bearer deletion request is a PDP context deletion request; and the S-GW deletes the bearer information about the UE-related to the SGSN.

Step 2005: The S-GW returns a bearer deletion response to the SGSN.

Step 2006: The SGSN returns a location deletion ACK to the HSS.

Step 2007: The HSS returns a location update ACK to the MME.

Step 2008: The MME sends a bearer deletion request to the S-GW.

In this step, the first network access control entity sends a bearer deletion request to the S-GW, and the S-GW deletes MME-related bearer information.

Step 2009: The S-GW initiates bearer deletion to the P-GW.

After the S-GW deletes the bearer information about the MME and the SGSN related to the UE, the S-GW initiates bearer deletion to the P-GW.

Step 2010: The S-GW returns a bearer deletion response to the MME.

The S-GW returns a bearer deletion response to the first network access control entity.

Step 2011: The UE returns a detachment Accept message to the MME.

Step 2012: The signaling connections are released.

The signaling connections between the UE and the NodeB and between the NodeB and the MME are released.

In this embodiment, the first network access control entity notifies the second network access control entity of performing the complete detachment in a mode different from that in the first embodiment to the eleventh embodiment. In addition, the execution sequence in this embodiment is different from that in the nineteenth embodiment. Further, the S-GW initiates bearer deletion to the P-GW only after the first network access control entity detaches the UE. This execution sequence is also applicable to the detachment request initiated by the MME. The complete detachment initiated by the SGSN in the 2G/3G network in case of signaling reduction is similar to the above solution except for the difference in the systems and message names, and is not further described. The bearer deletion method provided in this embodiment is also applicable to the complete detachment initiated by the UE in the LTE network and the 2G/3G network. The bearer deletion method provided in the nineteenth embodiment is also applicable to the complete detachment initiated by the MME and the SGSN, and is not further described.

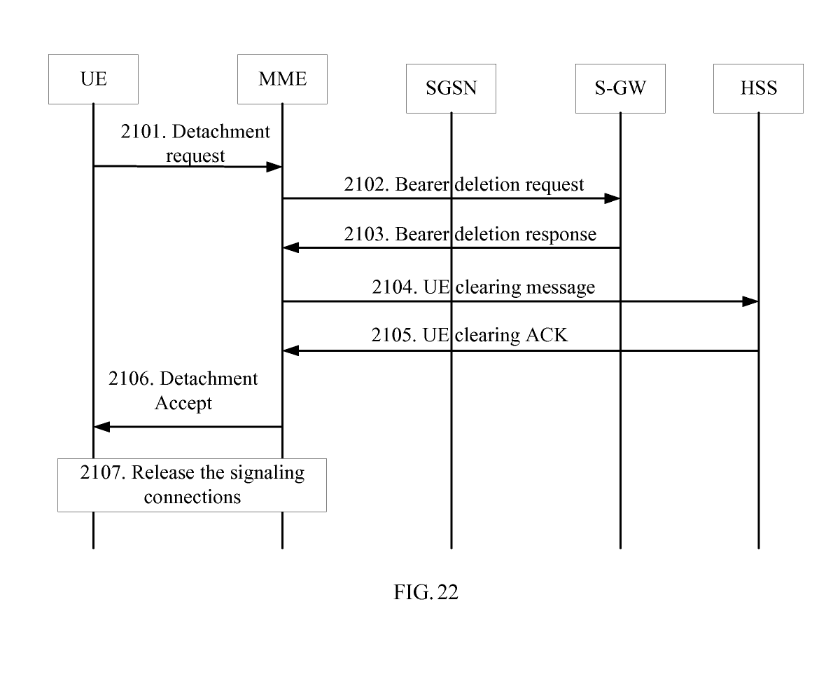

FIG. 22 is a flowchart of a method for detaching a UE according to the twenty-first embodiment of the present invention.

In the twelfth embodiment, the fourteenth embodiment, the sixteenth embodiment and the eighteenth embodiment, a single system is triggered to detach the UE from the system in case of single detachment. In this embodiment, after the first network access control entity detaches the UE, it does not notify the second network access control entity but notifies the HSS of deleting the information about the UE associated with the first network access control entity.

An embodiment provides a method for detaching a User Equipment (UE). The method includes: A UE detachment operation of a first network access control entity is triggered, wherein the type of the detachment operation is a single detachment operation; the first network access control entity performs the detachment operation according to the type of the detachment operation, and a Home Subscriber Server (HSS) is requested to set the first network access control entity to a cleared state.

Triggering a UE detachment operation of a first network access control entity includes: The first network access control entity determines to trigger a single detachment operation according to a preset condition; or the UE sends a detachment request message to the first network access control entity, wherein the type of the detachment request carried in the detachment request message is a single detachment.

Requesting an HSS to set the first network access control entity to a cleared state includes: The first network access control entity sends a UE clearing message to the HSS, wherein the UE clearing message carries an indication for deactivating signaling reduction; a UE clearing Acknowledgement message is returned to the UE; and the first network access control entity is set to a cleared state.

After an HSS is requested to set the first network access control entity to a cleared state, the method of an embodiment further includes The first network access control entity returns a detachment accept message to the UE.

Step 2101: The UE sends a detachment request to the MME. The request carries an indication indicating single detachment in the LTE network.

In this step, the detachment operation of the first network control entity (MME) is triggered, or the MME initiates a single detachment operation in the LTE network. When the MME initiates single detachment operation in the MME, the detachment request may carry a detachment type parameter indicating whether the UE is reattached. If the message carries a parameter indicating that the UE is reattached, step 2107 is not executed.

Step 2102: The MME sends a bearer deletion request to the S-GW.

In this step, the first network access control entity, that is MME, sends a bearer deletion request to the S-GW, and the S-GW deletes MME-related bearer information.

Step 2103: The S-GW returns a bearer deletion response to the MME.

The S-GW returns a bearer deletion response to the first network access control entity, that is MME.

Step 2104: The MME sends a UE clearing message to the HSS.

The UE clearing message carries an indication for deactivating signaling reduction, which may be a special cause value or other indication parameter IDs.

Step 2105: The HSS returns a UE clearing ACK to the UE.

The HSS sets the MME to the cleared state.

Step 2106: The MME returns a detachment Accept message to the UE.

Step 2107: The signaling connections are released.

The signaling connections between the UE and the NodeB and between the NodeB and the MME are released.

This embodiment is based on the fact that the UE triggers the UE detachment operation of the MME, and has the following difference from the twelfth embodiment, the fourteenth embodiment, the sixteenth embodiment and the eighteenth embodiment: After the first network access control entity detaches the UE, it does not notify the second network access control entity of already detaching the UE, but notifies the HSS of setting the first network access entity to the cleared state. The single detachment initiated by the UE in the 2G/3G network in case of signaling reduction and the single detachment initiated by the SGSN in the 2G/3G network are similar to the above solution except for the difference in the systems and message names, and are not further described.

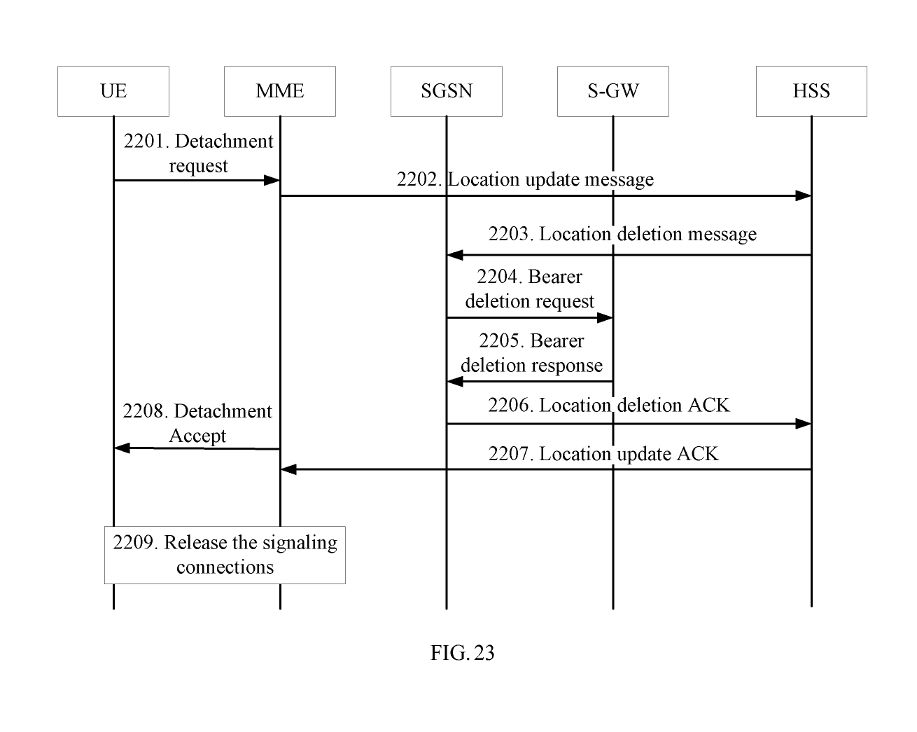

FIG. 23 is a flowchart of a method for detaching a UE according to the twenty-second embodiment of the present invention.

The preceding thirteenth embodiment, the fifteenth embodiment and the seventeenth embodiment describes a case where a system triggers another system to detach the UE from another single system under different network conditions. In this embodiment, when a system triggers another system to perform detachment in another system, the first network access control entity notifies the second network access control entity of performing single detachment. This embodiment provides a notification method different from that in the preceding thirteenth embodiment, the fifteenth embodiment and the seventeenth embodiment.

Step 2201: The UE sends a detachment request to the MME. The request carries an indication indicating single detachment in a 2G/3G network.

In this step, the first network control entity (MME) is triggered to perform the detachment operation, or the MME initiates a single detachment operation in the 2G/3G network. If the MME initiates a single detachment operation, the detachment request may carry a detachment type parameter indicating whether the UE is reattached. If the message carries a parameter indicating that the UE is reattached, step 2209 is omitted.

Step 2202: The MME sends a location update message to the HSS.

The location update message carries an indication for deactivating signaling reduction, a special cause value, a special value indicating the update type, or other indication parameters.

Step 2203: The HSS sends a location deletion message to the SGSN.

The location deletion message carries an indication for deactivating signaling reduction, a special cause value, a special value indicating the deletion type, or other indication parameters.

Step 2204: The SGSN sends a bearer deletion request to the S-GW.

In this step, the second network access control entity (SGSN) sends a bearer deletion request to the S-GW, where the bearer deletion request is a PDP context deletion request; and the S-GW deletes the bearer information about the UE-related to the SGSN.

Step 2205: The S-GW returns a bearer deletion response to the SGSN.

Step 2206: The SGSN returns a location deletion ACK to the HSS.

Step 2207: The HSS returns a location update ACK to the MME.

Step 2208: The MME returns a detachment Accept message to the UE.

Step 2209: The signaling connections are released.

The signaling connections between the UE and the NodeB and between the NodeB and the MME are released.

This embodiment uses a method different from that in the thirteenth embodiment, the fifteenth embodiment and the seventeenth embodiment when the first network access control entity triggers the single detachment of the second network access control entity. The single detachment in the LTE network initiated by the UE in the 2G/3G network and the single detachment in the LTE network initiated by the SGSN in case of signaling reduction are similar to the above solution except for the difference in the systems and messages, and are not further described.

Embodiments of the present invention describe an overall process of detaching the UE by complete detachment or single detachment in case of double registration and single registration when signaling reduction is activated. In addition, after the UE is detached from a network access control entity where the UE registers, another network access control entity may be notified by various means, so that another network access entity implements subsequent processes.

It is understandable to those skilled in the art that all or part of the steps of the foregoing embodiments may be implemented by hardware indicated by a program. The program may be stored in a computer readable storage medium. When being executed, the program performs one or any combination of the steps of the embodiments.

In addition, each functional unit in embodiments of the present invention may be integrated into a processing module, or exists independently, or two ore more units are integrated into a module. The integrated module may be implemented in the form of hardware or software. If the integrated module is implemented in the form of software and is sold or used as an independent product, the integrated module may also be stored in a computer readable storage medium.

The storage medium may be a read-only memory (ROM), a magnetic disk or a compact disk (CD).

What has been described above is a method for detaching a UE in embodiments of the present invention. Although the present invention has been described through several exemplary embodiments, the invention is not limited to such embodiments. It is apparent that those skilled in the art can make various modifications and variations to the invention without departing from the spirit and scope of the invention. The invention is intended to cover the modifications and variations provided that they fall in the scope of protection defined by the following claims or their equivalents.

What is claimed is:

1. A method for detaching a User Equipment (UE), comprising:
triggering a UE detachment operation of a first network access control entity, wherein the type of the detachment operation is a complete detachment operation;
performing, by the first network access control entity, the detachment operation according to the type of detachment operation;
triggering, by the first network access control entity, the complete detachment operation of a second network access control entity; and
performing, by the second network access control entity, the detachment operation according to the trigger operation of the first network access control entity.

2. The method for detaching a UE of claim 1, wherein the triggering the UE detachment operation of a first network access control entity comprises:
sending, by the UE, a detachment request carrying a complete detachment indication to the first network access control entity;
determining, by the first network access control entity to trigger the complete detachment operation according to a preset condition; or
sending, by a Home Subscriber Server (HSS), a location deletion message carrying a complete detachment indication to the first network access control entity.

3. The method for detaching a UE of claim 2, wherein the performing the detachment operation according to the type of detachment operation comprises:
sending, by the first network access control entity, a bearer deletion request to a Serving Gateway (S-GW); and
deleting, by the S-GW, the bearer information related to the first network access control entity.

4. The method for detaching a UE of claim 3, wherein the triggering the complete detachment operation of a second network access control entity comprises:
sending, by the first network access control entity, a complete detachment indication message to the second network access control entity.

5. The method for detaching a UE of claim 4, wherein the performing detachment operation according to the trigger operation of the first network access control entity comprises:
sending, by the second network access control entity, a bearer deletion request to instruct the S-GW to delete bearer information related to the second network access control entity.

6. The method for detaching a UE of claim 5, after deleting, by the S-GW, the bearer information related to the second network access control entity, further comprising:
initiating, by the S-GW, a bearer deletion to the P-GW.

7. The method for detaching a UE of claim 6, after the initiating, by the S-GW, bearer deletion to the P-GW, further comprising:
returning, by the S-GW, a bearer deletion response to the second network access control entity; and
returning, by the second network access control entity, a detachment Acknowledgement message to the first network access control entity.

8. A method for detaching a User Equipment (UE), comprising:
triggering a UE detachment operation of a first network access control entity, wherein the type of the detachment operation is a single detachment operation;
performing, by the first network access control entity, the detachment operation according to the type of detachment operation; and
notifying a second network access control entity that the first network access control entity has performed the detachment operation.

9. The method for detaching a UE of claim 8, wherein the triggering a UE detachment operation of a first network access control entity comprises:
sending, by the UE, a detachment request carrying a single detachment indication to the first network access control entity;
determining, by the first network access control entity to trigger the single detachment operation according to a preset condition; or
sending, by a Home Subscriber Server (HSS), a location deletion message to the first network access control entity, and initiating, by the first network access control entity, the single detachment operation according to the location deletion message.

10. The method for detaching a UE of claim 9, wherein the performing the detachment operation according to the type of detachment operation comprises:
sending, by the first network access control entity, a bear deletion request to a Serving Gateway (S-GW), wherein the S-GW does not need to initiate bearer deletion to a Packet Data Network (PDN) Gateway (P-GW);
deleting, by the S-GW, a Session Management (SM) context corresponding to a system where the first network access control entity is located; and
sending, by the S-GW, a bearer deletion response to the first network access control entity.

11. The method for detaching a UE of claim 10, after sending, by the S-GW, a bearer deletion response to the first network access control entity, further comprising:
sending, by the first network access control entity, a detachment indication message to the second network access control entity, wherein the type of detachment request carried in the detachment indication message is a single detachment, and indicates that the first network access control entity has detached the UE.

12. A method for detaching a User Equipment (UE), comprising:
triggering, by a first network access control entity, a UE detachment operation of a second network access control entity, wherein the type of the detachment operation is a single detachment operation; and
performing, by the second network access control entity, the detachment operation according to the type of the detachment operation.

13. The method for detaching a UE of claim 12, before the triggering, by a first network access control entity, a UE detachment operation of a second network access control entity, further comprising:
sending, by the UE, a detachment request message to the first network access control entity, wherein the type of detachment request carried in the detachment request message is a single detachment; or
determining, by the first network access control entity to trigger a single detachment operation.

14. The method for detaching a UE of claim 13, after the performing, by the second network access control entity, the detachment operation according to the type of detachment operation, further comprising:
returning, by the second network access control entity, a detachment response message to the first network access control entity, wherein the detachment response message indicates that the second network access control entity has detached the UE.

15. A system for detaching a User Equipment (UE), comprising:
a first device for determining to trigger complete detachment operation according to a preset condition,
a second device for performing the detachment operation; and
a third device for triggering the complete detachment operation of a second network access control entity.

16. The system of claim 15, wherein the second device comprises:
a transmitter for sending a bearer deletion request to a Serving Gateway (S-GW).

17. The system of claim 15, wherein the third device comprises:
a transmitter for sending a complete detachment indication message to the second network access control entity.
